(19) United States
(12) Patent Application Publication
(10) Pub. No.: US 2002/0075513 A1
(43) Pub. Date: Jun. 20, 2002

(54) Method of controlling image forming apparatus and recording medium

(76) Inventors: Keyaki Yogome, Kyoto-Shi (JP); Hiroshi Mizuno, Ikoma-Shi (JP); Hidetoshi Miyamoto, Takatsuki-Shi (JP); Masahiko Matsuura, Suita Shi (JP); Takaji Kurita, Osakasayama-Shi (JP)

Correspondence Address: MCDERMOTT, WILL & EMERY, 600 13th Street, N.W., Washington, DC, 20005-3096, US

(21) Appl. No.: 09/878,170

(22) Filed: Jun. 12, 2001

(30) Foreign Application Priority Data
Jun. 12, 2000 (JP) 2000-215197

(51) Int. Cl. G06F 15/00; G09G 3/36

(52) U.S. Cl. 358/1.15

(57) ABSTRACT

A method of controlling an image forming apparatus having a first image forming portion for forming an image on a normal image display medium and a second image forming portion for forming an image on a reversible image display medium, comprising the steps of:

transmitting at least one of information of state(s) about the image forming apparatus and information about an input state caused by a user in the apparatus to an image information input apparatus; and carrying out, based on the information, and an input state caused by the user, the image data and an application software in the image information input apparatus and a type of the image information input apparatus,

at least one of (1) selection of a method of processing the image data to be transmitted, (2) change of the state of the image forming apparatus and (or) the setting state for image formation of the image forming apparatus in the image information input apparatus, and (3) change of the state of the image forming apparatus and (or) the setting state for image formation of the image forming apparatus in the image forming apparatus.

A computer readable recording medium storing a program for executing control of the image forming apparatus.

The invention is based on the patent application No. 2000-215197 Pat. filed in Japan, the contents of which are hereby incorporated by reference.

### BACKGROUND OF THE INVENTION

1. Field of the Invention

The present invention relates to a method of controlling an image forming apparatus, which can form images on a normal image display medium such as a normal paper sheet as well as a rewritable and reversible image display medium.

The present invention also relates to a recording medium storing a program.

2. Description of the Background Art

At present, texts, graphics or the like prepared by a computer, a word processor or the like are displayed, for example, on a CRT display or the like, or are displayed by outputting them on a medium such as a paper sheet via a printer or the like.

However, the image display on the display such as a CRT display cannot achieve high resolutions as compared with images displayed, e.g., by printers on paper sheets, and can not display images with sufficiently high clearness and accuracy. Due to relatively low resolution and light emitted from the CRT or the like, an operation viewing images displayed on the CRT or the like for a long time causes fatigue in operator's eyes.

In contrast to the above, the display of texts and graphics on the image display mediums such as paper sheets can be performed with high clearness and high resolution, and therefore can be easy-on-the-eyes image display.

For the above reasons, texts, graphics and others prepared by the computer, word processor or the like are output onto mediums such as paper sheets by a printer or the like in almost every case even when it is necessary to read only temporarily the text or the like, or the texts are a draft which may be further revised.

The mediums such as paper sheets bearing images are abandoned or burnt when they are no longer required. This results in consumption of a large mount of resources. The printer or the like also consumes a large amount of consumable products or materials such toner, ink or thermal transfer sheets. For obtaining the new display mediums such as paper sheets or the like as well as toner, ink or the like, manufacturing energies and resources are required.

This is contrary to the current demand for reduction in environmental loads.

### SUMMARY OF THE INVENTION

The inventors have researched and developed an image forming apparatus which can form images on normal image display mediums such as normal paper sheets as well as reversible (i.e., image-writable, image-erasable and image-rewritable) image display mediums, can satisfy current demands for reduction in environmental loads owing to image formation on the reversible image display mediums allowing rewriting and therefore repetitive use, and does not cause a substantial problem compared with the conventional image forming apparatus owing to conventional image formation on the normal image display mediums.

In such an image forming apparatus, however, since an image can be formed on both a normal image display medium and a reversible image display medium, an image forming operation is likely to be complicated.

It is an object of the present invention to provide a method of controlling the image forming apparatus in which an image forming operation for the image forming apparatus can be understood readily and eased.

Moreover, it is an object of the present invention to provide a recording medium storing a program for executing the method of controlling the image forming apparatus.

The present invention provides a method of controlling an image forming apparatus having a first image forming portion for forming an image on a normal image display medium and a second image forming portion for forming an image on a reversible image display medium and capable of forming an image on the normal image display medium by the first image forming portion and of forming an image on the reversible image display medium by the second image forming portion, comprising the steps of:

transmitting at least part of information about the image forming apparatus to an image information input apparatus for transmitting image data to the image forming apparatus; and

carrying out, based on at least one of the information to be transmitted from the image forming apparatus to the image information input apparatus and information about the image information input apparatus,

at least one of (1) selection of a method of processing the image data to be transmitted to the image forming apparatus in the image information input apparatus, (2) change of a state of the image forming apparatus in the image information input apparatus, and (3) change of a state of the image forming apparatus in the image forming apparatus.

The information about the image forming apparatus may include at least one of information about a state of a predetermined item in the image forming apparatus, information about a setting state for image formation in the image forming apparatus and information about an input state caused by a user in the image forming apparatus.

The information about the image information input apparatus may include at least one of an input state caused by the user in the image information input apparatus, the image data in the image information input apparatus, an application software to be used in the image information input apparatus and a type of the image information input apparatus.

Moreover, the present invention provides a computer readable recording medium storing a program for controlling an image forming apparatus comprising a first image forming portion for forming an image on a normal image display medium and a second image forming portion for forming an image on a reversible image display medium and capable of forming an image on the normal image display medium by the first image forming portion and of forming an image on the reversible image display medium by the second image forming portion, the program enabling the computer to perform the steps of:

receiving information about the image forming apparatus transmitted from the image forming apparatus to an image information input apparatus for transmitting image data to the image forming apparatus; and

executing at least one of (1) selection of a method of processing the image data to be transmitted to the image forming apparatus in the image information input apparatus and (2) change of a state of the image forming apparatus in the image information input apparatus, based on at least one of the information to be transmitted from the image forming apparatus to the image information input apparatus and information about the image information input apparatus.

With respect to the recording medium, the information about the image forming apparatus may include at least one of information about a state of a predetermined item in the image forming apparatus, information about a setting state for image formation in the image forming apparatus and information about an input state caused by a user in the image forming apparatus.

The information about the image information input apparatus may include at least one of an input state caused by the user in the image information input apparatus, the image data in the image information input apparatus, an application software to be used in the image information input apparatus and a type of the image information input apparatus.

According to the method of controlling an image forming apparatus and the recording medium, the information in the image forming apparatus is transmitted to the image information input apparatus, and a user can execute, based on the transmitted information and the information or state in the image information input apparatus, at least one of job controls including (1) selection of the method of processing the image data to be transmitted to the image forming apparatus in the image information input apparatus, (2) change of the state of the image forming apparatus and (or) the setting state for image formation of the image forming apparatus in the image information input apparatus, and (3) change of the state of the image forming apparatus and (or) the setting state for image formation of the image forming apparatus in the image forming apparatus, and can properly take measures for various states, situations and the like. Correspondingly, the image forming operation can be readily understood and eased.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIGS. 1(A) and 1(B) show an example of an image display medium of a dry chargeable particle containing type,

FIG. 1(A) is a cross section showing an example before image display, and

FIG. 1(B) is a cross section showing an example during image display;

FIG. 2 is a plan showing the image display medium shown in FIG. 1(A) with a certain part cut away;

FIG. 3 shows an example of a structure of an image display medium of an electrophoresis type;

FIG. 4 shows an example of a structure of an image display medium of a twist ball type;

FIG. 5 shows an example of a structure of an image display medium of a magnetic drive type;

FIG. 6 shows a schematic structure of an example of the image forming apparatus;

FIG. 7 is a block diagram schematically showing a control circuit of the apparatus shown in FIG. 6;

FIG. 8 shows a schematic structure of another example of the image forming apparatus;

FIG. 9 shows a schematic structure of further another example of the image forming apparatus;

FIG. 10 is a flow chart showing an example of control;

FIG. 11 is a view showing an example of medium type detection through a test printing mechanism;

FIGS. 12(A) to 12(C) are views showing an example of the medium type detection through the shape of a medium,

FIG. 12 (A) is a view showing an example in which the corner portion of the medium is cut,

FIG. 12(B) being a view showing an example in which the corner portion of the medium is provided with a transmission hole, and

FIG. 12(C) is a view showing an example in which the medium is detected by an optical sensor provided on the slightly upstream side of a timing roller pair;

FIGS. 13(A) to 13(C) are views showing an example of medium type detection through a character or the like on the medium;

FIG. 14 is a flow chart showing another example of the control;

FIG. 15 is a flow chart showing yet another example of the control;

FIG. 16 is a flow chart showing a further example of the control;

FIG. 17 is a flow chart showing a further example of the control;

FIG. 18 is a flow chart showing a further example of the control;

FIG. 19 is a flow chart showing a further example of the control;

FIG. 20 is a flow chart showing a further example of the control;

FIG. 21 is a flow chart showing a further example of the control;

FIGS. 22(A) to 22(C) are views showing an example of a medium type detecting device,

FIGS. 22(A) and 22(B) are plan views showing an example of a medium TP in which a medium type can be detected and

FIG. 22(C) is a view showing a state in which the medium is detected;

FIGS. 23(A) to 23(D) are views showing another example of the medium type detecting device,

FIGS. 23(A) and 23(C) are plan views showing another example of the medium TP in which a medium type can be detected and

FIGS. 23(B) and 23(D) are views showing a state in which the medium is detected;

FIGS. 24(A) and 24(B) are views showing yet another example of the medium type detecting device,

FIG. 24(A) shows a state in which a medium TP is detected by means of a special cassette for accommodating the medium TP and

FIG. 24(B) shows a state in which a medium PP is detected by means of a special cassette for accommodating the medium PP; and

FIGS. 25(A) and 25(B) are views showing a further example of the medium type detecting device,

FIG. 25(A) shows a state in which a medium TP is detected by means of a special cassette for accommodating the medium TP and

FIG. 25(B) shows a state in which a medium PP is detected by means of a special cassette for accommodating the medium PP.

### DESCRIPTION OF THE PREFERRED EMBODIMENTS

A preferred embodiment of the present invention provides a method of controlling an image forming apparatus having a first image forming portion for forming an image on a normal image display medium and a second image forming portion for forming an image on a reversible image display medium and capable of forming an image on the normal image display medium by the first image forming portion and of forming an image on the reversible image display medium by the second image forming portion.

The control method comprises the steps of:

transmitting at least one of information about a state of a predetermined item in the image forming apparatus, information about a setting state for image formation in the image forming apparatus and information about an input state caused by a user in the image forming apparatus to an image information input apparatus for transmitting image data to the image forming apparatus; and

carrying out, based on at least one of the information to be transmitted from the image forming apparatus to the image information input apparatus, an input state caused by the user in the image information input apparatus, the image data in the image information input apparatus, an application software to be used in the image information input apparatus and a type of the image information input apparatus,

at least one of (1) selection of a method of processing the image data to be transmitted to the image forming apparatus in the image information input apparatus, (2) change of the state of the predetermined item of the image forming apparatus and (or) the setting state for image formation of the image forming apparatus in the image information input apparatus, and (3) change of the state of the predetermined item of the image forming apparatus and (or) the setting state for image formation of the image forming apparatus in the image forming apparatus.

In the control method, an information about an image data in the image forming apparatus may be included in the information to be transmitted from the image forming apparatus to the image information input apparatus if necessary.

A preferred embodiment of the present invention provides a computer readable recording medium storing a program for controlling an image forming apparatus comprising a first image forming portion for forming an image on a normal image display medium and a second image forming portion for forming an image on a reversible image display medium and capable of forming an image on the normal image display medium by the first image forming portion and of forming an image on the reversible image display medium by the second image forming portion.

The program enables the computer to perform the steps of:

receiving information about a state of a predetermined item in the image forming apparatus, information about a setting state for image formation in the image forming apparatus and information about an input state caused by a user in the image forming apparatus, which are transmitted from the image forming apparatus to an image information input apparatus for transmitting image data to the image forming apparatus; and

executing at least one of (1) selection of a method of processing the image data to be transmitted to the image forming apparatus in the image information input apparatus and (2) change of the state of the predetermined item of the image forming apparatus and (or) the setting state for image formation of the image forming apparatus in the image information input apparatus, based on at least one of the information to be transmitted from the image forming apparatus to the image information input apparatus, an input state caused by the user in the image information input apparatus, the image data in the image information input apparatus, an application software to be used in the image information input apparatus and a type of the image information input apparatus.

If an information about an image data in the image forming apparatus can be transmitted from the image forming apparatus to the image information input apparatus, a program enabling receipt of the information may be stored in the recording medium, if necessary.

In any case, the recording medium may be releasably or detachably attached to the image information input apparatus or may be fixedly attached to the image information input apparatus.

The “state of a predetermined item in the image forming apparatus” and the like will be described below.

<State in Image Forming Apparatus>

For example, the “state of a predetermined item in the image forming apparatus” can be roughly classified into:

(A1) a state of the image display medium;

(A2) a state of image forming element(s) (a developing device, a fixing device and the like);

(A3) an operation mode of the image forming apparatus; and

(A4) a situation of error generation.

They are described below, respectively.

In some cases, the “image display medium” may be hereinafter referred to as a “medium”.

In some cases, the normal image display medium such as a paper sheet may be referred to as a “medium PP” or “PP”.

In some cases, the reversible image display medium may be referred to as a “medium TP” or “TP”.

(A1) Information about the Image Display Medium

a type of a prepared medium, a state of an image forming surface in the medium, a medium shortage, a direction of the surface (front side) and back face (back side) of the medium (a state of error of directions of the surface and back face), an error of a medium type, the setting of the medium type, the presence of overwrite prohibition in the medium, the presence of a medium feeding cassette, a medium TP and the like.

(A2) A State of Image Forming Element(s)

a set position and a developing mode of a developing device, a set position, a fixing mode and a fixing temperature of a fixing device, and a state of each of elements such as a cleaner, a transfer mechanism, a medium transporting mechanism and the like.

(A3) An Operation Mode of a Printer (Image Forming Apparatus)

a standby mode, an energy saving mode, a starting mode, a print mode, a communication mode and the like.

(A4) A Situation of Error Generation

a medium jam, a medium shortage, a setting mistake and the like.

The information about the medium of the (A1) can be obtained by utilizing various medium type detecting devices which will be described later in explanation of image forming apparatus setting. The information can also be obtained by the manual input by a user.

In detection of the state of the medium TP, the degree of deterioration, a lifetime, the number of uses, overwrite prohibition information, initialization of medium TP and the like may be detected.

For displaying the state of the medium TP which are related to the degree of deterioration, the lifetime and the number of uses, various methods can be employed. For example, the medium TP is marked, printing is carried out thereon, a mark such as a bar code is put thereon.

A test printing mechanism may be provided on a medium transporting path on the upstream side of the printing portion of the image forming apparatus, and thereby the state may be detected based on a change in color, contrast and the like in the printing portion of medium TP. The overwrite prohibition can be detected by various detecting devices by determining an overwrite prohibition mark, a sign, a mechanism and the like.

In the detection of the state of various elements in the image forming apparatus in the (A2), it is possible to detect the operation mode of the image forming apparatus and/or the state of the element(s), which might be changed in setting depending on the operation mode of the image forming apparatus, such as 1) a set position and a mode of a developing device, 2) a set position, a mode and a fixing temperature of a fixing device, 3) set positions and modes of a cleaner and a image transfer mechanism and selections of a medium feeding cassette and medium discharge tray, which relate to medium transportation.

For the detection of the temperature of the fixing device, a temperature detecting device for temperature control provided in the fixing device may be utilized. A device for detecting a temperature of the medium TP may be also employed.

The situation of error generation such as the medium jam, the medium shortage or the setting mistake in the (A4) can be detected by ,e.g., error detecting devices provided in the image forming apparatus.

It is also possible to provide an error detecting device special for the medium TP, for example, to detect the lifetime of the medium TP.

<Setting State for Image Formation in Image Forming Apparatus>

For example, the “setting state for image formation in the image forming apparatus” can be roughly classified into (B1) a setting state of a medium in the image forming apparatus and (B2) an image forming mode (print mode). Each of them will be further described as follows.

(B1) Medium Setting State

For example, the medium setting is detected by a system including the image forming apparatus or is detected through the manual medium setting input of a user.

In the former case, various medium type detecting devices can be utilized. By detecting a medium type through the medium type detecting device, a medium type to be used for image formation can also be set.

Examples of the medium type detecting device include the following:

a) a device for detecting that a medium to be used for image formation is a normal image display medium (medium PP) such as a plain paper (normal paper sheet) or a reversible image display medium (medium TP) based on a medium display portion provided at a image display medium accommodating cassette to be attached to a cassette attaching portion provided in the image forming apparatus; and

b) a device for detecting that an medium to be used for image formation is the medium PP or the medium TP based on an medium display portion provided at the medium accommodated in a cassette to be attached to a cassette attaching portion provided in the image forming apparatus.

As examples of the medium display portion provided at the medium in the case of the medium detecting device of the latter b), it is possible to utilize the size of the medium, a cut, a notch, a transmission hole, a special sign or mark which is provided ,e.g., on the medium TP, various physical properties such as an electrostatic capacity, a surface resistance, a conductivity, a quantity of magnetism, a spectral reflecting characteristic, a thickness, an air transmission ratio, a weight and a flexibility in the medium in order to distinguish the medium TP from the medium PP.

By detecting these medium display portions through various sensors such as an optical sensor, the medium type can be detected and set.

c) In addition, it is also possible to include a device having a test printing mechanism provided on a medium transporting path on the upstream side of the image forming portion (printing portion) of the image forming apparatus and a sensor for detecting a change in physical properties of a portion to be printed on the medium through the printing mechanism. For example, it is possible to detect the medium type by detecting the presence of a change in a color of the medium through the printing operation on the medium by the test printing mechanism.

Examples of the case in which the user manually inputs the medium setting include the case in which a medium type to be used for image formation is selected and designated by the user in a medium type selection portion provided on an operation panel of the image forming apparatus, the case in which the user operates a medium selecting mechanism provided on a cassette and accommodates a predetermined medium therein and a sensor provided in the cassette attaching portion detects the result of the operation in the selecting mechanism, thereby detecting the medium type and setting the medium to be used for the image formation and the like.

(B2) Image Forming Mode (Print Mode)

Examples of the image forming mode include a PP mode, a TP mode, a trial print mode, an editorial print mode and the like.

The PP mode indicates a mode for printing on the medium PP in which image information (image data) is optimized for the medium PP and is printed.

The TP mode indicates a mode for printing on the medium TP in which image information (image data) is optimized for the medium TP and is printed.

The trial print mode indicates a mode in which image information is printed in the TP mode by using the medium TP and is then printed again on the medium PP in the PP mode in accordance with the image data retained in an image data storage portion provided on the image forming apparatus.

The editorial print mode includes a mode in which a plurality of pages are printed into one sheet, a mode in which an image is enlarged or reduced to be printed, a mode in which an image is partially enlarged or reduced to be printed, a mode in which an image is subjected to variable power(magnification) print vertically and/or horizontally and the like.

Examples of other mode setting include an erase mode, an overwrite prohibition mode, a print end mode, a forced stop mode, a forced discharge mode and the like.

The erase mode indicates a mode in which an image is erased from the medium TP having the image written thereto and white solid printing, black solid printing, optional image printing or the like may be carried out.

The overwrite prohibition mode indicates a mode in which a processing of ending the print, forcibly discharging a paper or the like is executed when overwrite prohibition information is detected by means of any device or an image has already been written.

The print end mode and the forced stop mode indicate a mode in which the print is stopped in the image forming apparatus when the print should be stopped through error detection or the like.

The forced discharge mode indicates a mode to be utilized when the medium type should be forcibly discharged in printing operation due to a selection error or the like.

<Input State by User>

Examples of an input to influence the result of print which is to be carried out by a user include:

a setting operation of a printer driver such as a resolution, a print speed, a print mode, medium setting, allocation, overlay, a half tone, color information, a gradation, a print grade, the number of parts or the number of print pages on an image information input apparatus such as a computer; and

various operations such as a key operation for setting a PP mode, a TP mode, medium type, a trial print mode or the like on the image forming apparatus (printer).

<Image Data (Print Data>

Image data (print data) indicate information, for example, data on image formation (print), a style, a mail header, an inherent format such as an htlm format, a data size, color information, a gradation, the number of print pages, the number of print parts, a resolution, a half tone, a change history, a difference between image data in a page memory and transmitted image data and the like.

<Application or Application Software>

An application (application software) indicates an application (application software) for giving a print operation instruction. Foe example, a word processor, a text calculating software, a mailer, an htlm reading software and the like are mentioned.

<Type of Image Information Input Apparatus>

An image information input apparatus indicates an apparatus for transmitting image information onto an image forming apparatus (printer) and includes an apparatus for directly operating image data and an apparatus for relaying transmitted data to the printer, for example, a computer such as a personal computer, a facsimile receiver, a print server and the like.

Next, description will be given to job control such as the “Selection of Method of Processing Image Data to be Transmitted to Printer (image forming apparatus)”.

<Selection of Method of Processing Image Data to be Transmitted to Printer>

The selection of the method of processing image data implies the selection of a processing method from a plurality of processing methods in which a method of processing printing data and an apparatus for the processing are combined.

The examples of the processing method includes a modulation of a resolution, a change of color information, a change of number of gradations, an addition and change of information about a state of a medium TP (degree of deterioration, number of uses, sign or the like), and an addition and change of information such as a sign, a character or an image for a medium (for example, medium TP), and therefore, the processing method indicates a processing of obtaining different results of print by applying the change, addition and deletion to the original printing data. As a matter of course, the result of a processing may be identical to the original result of print.

The information such as a sign, a character or an image may be either significant or insignificant, and various printing data such as information about advertisements or printer error information can be changed or added.

All the printing data do not need to be controlled. The result of the processing may be identical to the original printing data. The printing data may be exactly printed as a result of an input to the image forming apparatus.

An apparatus for processing the printing data includes a personal computer, a printer, a print server, a facsimile device and the like, any of which can be used for the processing. Moreover, data processed on the personal computer may be processed again on the print server, and may be thus processed plural times through a plurality of apparatuses or devices.

<Change of State of Image Forming Apparatus and Change of Setting State of Image Forming Apparatus>

The state of the image forming apparatus and the setting state of the image forming apparatus are preferably changed in an image information input apparatus or may be changed in the image forming apparatus if necessary.

The states may be displayed in the image information input apparatus, and the states of the image information input apparatus and/or the image forming apparatus may be changed manually.

The contents of the change for the state of the image forming apparatus and the setting state of the image forming apparatus include various states described in the <State of Image Forming Apparatus>and <Setting State for Image Formation in Image Forming Apparatus>.

Control of the <Selection of Method of Processing Image Data to be Transmitted to Image Forming Apparatus>and (or) the <Change of State of Image Forming Apparatus and Change of Setting State of Image Forming Apparatus>is carried out according to detection for the <State of Image Forming Apparatus>and (or) the <Setting State for Image Formation in Image Forming Apparatus>. The detection and the control do not need to be single but a plurality of detecting operations may be combined to carry out a plurality of processings.

Examples will be collectively shown in the following table, although not restricted thereto.

| Operation | | |
|---|---|---|
| instruction | Content of detection | Control |
| Print in TP | Medium type of PP | Set print mode of printer to PP. Print in PP mode. |
| Print in TP | Medium type of PP | Set print mode of printer to PP. Data for TP print is |
| | | transmitted. Print in PP mode. |
| Print in TP | Printing surface of TP turned over | Forcibly discharge a medium. Change a discharge tray to a |
| | | subtray. |
| Print in PP | PP is not present and TP is present. | Change print mode of printer TP. Print in TP mode. |
| Print in TP | Cassette for TP is attached. | Set print mode of printer to PP. Data for TP print is |
| | Medium type of PP | transmitted. Print in PP mode. |
| Print in TP | Overwrite prohibition display on TP | Forcibly discharge a medium. Change a discharge tray to a |
| | | subtray. Print again. Discharge a medium to a main tray. |
| Print in TP | TP is deteriorated. | Add a display of “the sheet is deteriorated” to a lower portion |
| | | of a medium and print. |
| Print in TP | No lifetime of TP. Print cannot be carried | Forcibly discharge a medium. Change a discharge tray to a |
| | out. | subtray. Print again. Discharge a medium to a main tray. |
| Print in PP | PP feeding portion has a paper jam and TP | Change to TP print mode and print in TP. At the same time, |
| | feeding portion is normal. | add a display of “a PP feeding portion has a paper jam” to |
| | | a lower portion of TP and print. |
| Print in PP | TP is not present. | Change to TP print mode and print in TP. At the same time, |
| | | add a display of “PP is not present” to a lower portion of |
| | | TP and print. |
| Print in PP | Medium type of TP | Forcibly stop |
| Print in TP | Fixing device has a high temperature. | Forcibly stop |
| Print in TP | Fixing device has a high temperature. | Print in PP mode |
| Print in TP | Fixing device has a high temperature. | Stand by until the temperature of the fixing device is lowered. |
| | | Start the print after cooling is completed. |
| Print in PP | Developing device is set in retreat and | Change to TP print mode and print in TP. At the same time, |
| | inoperative state. | print a mark showing “trouble” of developing device on a |
| | | lower portion of TP. |
| Print in PP | Standby mode, TP print mode | Change to PP print mode and print. |

The first image forming portion for forming the image on the normal image display medium may be of an indirect recording type or a direct recording type.

As a typical example, the image forming portion of the indirect recording type may be of an electrophotographic type configured to form the image by forming an electrostatic latent image corresponding to the image to be displayed on an electrostatic latent image carrier, developing the electrostatic latent image into a toner image and transferring the toner image onto the normal image display medium for fixing the same.

The image forming portion of the direct recording type may be of an ink-jet type configured to form an image by ejecting ink onto the image display medium in accordance with the image to be formed, may be of a sublimation transfer type configured to form the image by thermally transferring ink from a transfer film carrying sublimation ink onto the image display medium in accordance with the image to be formed, or may be of a thermal transfer type configured to form the image by thermally transferring thermal ink applied over transfer film onto the image display medium in accordance with the image to be formed.

The normal image display medium may be a normal paper sheet, an overhead projector sheet or the like as already described, and an appropriate image display medium can be from among them in accordance with the method of forming the image on the normal image display medium by the first image forming portion.

For example, the second image forming portion may be configured:

to display the image on the reversible image display medium of the electric field drive type by an electric field corresponding to the image to be formed, or

to display the image on the reversible image display medium of the magnetic drive type by a magnetic field corresponding to the image to be formed.

The reversible image display mediums of the electric field drive type and the magnetic drive type will be described later. The image forming portion for the reversible image display medium will also be described later.

When using the reversible image display medium of the electric field drive type containing magnetic developer particles, the second image forming portion may be provided with a device for magnetically stirring dry developer particles for forming the image on the reversible image display medium by an electric field.

The reversible image display medium of the electric field drive type as described above may be an image display medium of a dry chargeable particle containing type, an electrophoresis type, a twist ball type or the like. These will now be described.

<Image Display Medium of Dry Chargeable Particle Containing Type>

A reversible image display medium includes dry developer particles contained in developer containing cell(s), which is(are) formed between two substrates (at least one having light transparency) opposed to each other with a predetermined gap therebetween. The dry developer contains two kinds of frictionally chargeable dry developer particles having different chargeable polarities and having different optical reflection densities (in other words, providing “different degrees of contrast” or “different colors”).

According to the image display medium, an electric field corresponding to the image to be displayed is applied while at least two kinds of dry developer particles are frictionally charged to different polarities, respectively, and thereby the developer particles charged to the respective polarities move in the opposite directions depending on the direction of the electric field within the medium so that an image having contrast is displayed.

The medium of dry chargeable particle containing type may also be as follows:

This reversible image display medium also includes dry developer contained in developer containing cell(s), which is(are) formed between two substrates (at least one having light transparency) opposed to each other with a predetermined gap therebetween. The dry developer contains two kinds of frictionally chargeable dry developer particles having different chargeable polarities and having different optical reflection densities (in other words, providing “different degrees of contrast” or “different colors”). At least one kind of the developer particles are magnetic particles.

On this image display medium, the image can be displayed similarly to the foregoing image display medium of the dry chargeable particle containing type. Since at least one kind of the developer particles forming the dry developer are magnetic particles, the developer (developer particles) can be stirred with a magnetic field such as an oscillating magnetic field. This stirring of the developer promotes the movement of the developer particles in the operations of initialization of the medium, erasing (a kind of initialization) of the last image prior to the image formation (image display) and displaying the image in the electric field (electrostatic field) for image display. These can improve the image display.

When using the reversible image display medium of the dry chargeable particle containing type employing the foregoing magnetic particles, the image forming portion for forming the image thereon may be provided with a device for magnetically stirring the dry developer particles when forming the image by the electric field on the reversible image display medium.

The developer particles contained in the cell(s) may have a particle diameter in a range from about 1 μm to about 100 μm. The developer particles may be fine particles having such a structure that various kinds of coloring agent, charge control agent and others are dispersed in the binder resin. A third component (particles) such as a fluidity improving agent may be added and mixed.

<Image Display Medium of Electrophoresis Type>

In this medium, a closed space is formed between two substrates opposed to each other with a spacer therebetween, and is filled with display liquid formed of particles having electrophoretic mobility and a dispersion medium having a color different from that of the particles and containing the particles in a dispersed fashion. The image is displayed in the color of the particles or the dispersion medium by applying the electric field corresponding to the image to be displayed and thereby moving the particles in the display liquid.

The display liquid is generally formed of dispersion medium containing isoparaffin or the like, particles of, e.g., titanium dioxide, dye for providing contrast in color with respect to the particles, a dispersion agent such as a surface active agent and additives such as a charge applying agent.

<Image Display Medium of Twist Ball Type>

A typical example is a medium known as gyricon-base electronic paper display. This medium usually has a sheet-like form, and is disclosed in U. S. Pat. Nos. 4,126,854 and 4,143,103, although not restricted thereto. In the medium of twist ball type, two-color spherical members each having an outer surface formed of halves, which are different in color (e.g., white on one of the semi-spherical surfaces, and another color (e.g., black) on the other), are surrounded by liquid, wax or the like, and the spherical members thus surrounded fill cavities in an insulating property holding medium. By applying an external electric field corresponding to the image, the spherical members rotate within the cavities in accordance with their electrical anisotropy so that the image is displayed. The medium may be configured such that the image can be displayed by heating it to a temperature higher than the melting point of wax surrounding the spherical members and by applying an external electric field, and the image can be fixed by cooling it to a temperature not exceeding the wax melting point.

<Reversible Image Display Medium of Magnetic Drive Type>

The following reversible image display mediums of the magnetic drive type can be used depending on the structure of the image forming portion.

(a) An image display medium, in which dispersion liquid containing magnetic particles dispersed therein is held in cell(s) formed between two substrates opposed to each other with a predetermined gap therebetween, and the magnetic particles have an optical reflection density different from that of the dispersion liquid.

(b) An image display medium, in which a coating layer of micro-capsules filled with dispersion liquid containing magnetic particles dispersed therein is formed on one side of a substrate, and the magnetic particles in the micro-capsules have an optical reflection density different from that of the dispersion liquid.

Rewritable (reversible) image displays other than the above described reversible image display mediums can be used.

From the viewpoint of the drive type, the reversible image display may be of a matrix drive type having electrodes (e.g., individual electrodes for the respective pixels). In this case, a controller for applying a signal to the electrodes may be employed. The display may have an image storing property for storing and holding the written image even after stop of the application of the voltage to the electrode.

From the viewpoint of the medium used for display, the reversible image display may be a panel display such as a liquid crystal display or an electro-luminescence display.

Any one of these reversible image display mediums (or reversible image displays) allows image displaying(image-writing), image-erasing and image rewriting by selecting an electric field or a magnetic field applied thereto, and therefore allows repetitive use. Accordingly, it is not necessary to abandon them. The external supply or addition of the developer is not required. Owing to these facts, it is possible to reduce remarkably the use of the image display medium such as paper sheets as well as consumable materials such as conventional developer particles, ink or the like.

The following image forming portions for the reversible image display mediums of the electric field drive type and the magnetic field drive type can be employed.

<Image Forming Portion for Reversible Image Display Medium of Electric Field Drive Type>

On the reversible image display medium of the electric field drive type, the image can be formed by applying the electric field (electrostatic field), which corresponds to the image to be formed, on the medium. Accordingly, the image forming portion for forming such an electric field (electrostatic field) can be configured to utilize an electrostatic latent image or to utilize a write electrode.

Image Forming Portion Utilizing Electrostatic Latent Image

This image forming portion is configured such that an electrostatic latent image corresponding to the image to be displayed is formed on one (e.g., the substrate on the image observation side) of the two substrates of the medium, or an externally formed electrostatic latent image is brought closer to the medium so that the electrostatic field is formed based on the electrostatic latent image.

The formation of the electrostatic field described above may be performed simultaneously with or after formation of the electrostatic latent image. The electrostatic field may be formed by applying a predetermined potential for formation of the electrostatic field on the substrate opposite to the substrate, on which the electrostatic latent image is to be formed or brought closer. Setting of the predetermined potential can be performed, e.g., by applying a bias to an opposite electrode, which is formed on in advance or is in contact with the opposite substrate, or by grounding the opposite electrode.

The electrostatic latent image may be formed directly on the medium surface (substrate surface), e. g., by a device for directly forming electrostatic latent image, or may be formed by transferring an external electrostatic latent image formed outside the medium by an external electrostatic latent image forming device on the medium surface (substrate surface). The external electrostatic latent image may be brought closer to the medium surface.

The direct electrostatic latent image forming device may be of various discharging types, which are configured to place electrostatic latent image charges by effecting discharging on the medium surface in accordance with the image to be displayed, and also may be of various charge supplying types, which are configured to place electrostatic latent image charges by injecting charges into the medium surface in accordance with the image to be displayed. As examples of the former, a device of an ion-flow type and a device of a multi-stylus type can be employed. The device of the multi-stylus type has an electrostatic record head, in which recording electrodes are arranged in a predetermined direction (e.g., in a main scanning direction for scanning the substrate with the device). As an example of the latter device, a device of a multi-stylus type can be employed, which has an electrostatic recording head, in which recording electrodes are arranged in a predetermined direction (e.g., in a main scanning direction for scanning the substrate with the device), and neighboring control electrodes neighbor to the recording electrodes.

The external electrostatic latent image forming device may be of such a type that an electrostatic latent image corresponding to the image to be displayed is formed on an electrostatic latent image carrier, and the electrostatic latent image on the electrostatic latent image carrier is transferred onto or brought closer to the surface of the medium substrate. More specifically, the electrostatic latent image corresponding to the image to be formed is formed, e. g., on a photoconductive member such as a photosensitive member, and the electrostatic latent image on the photoconductive member is transferred onto or brought closer to the surface of the medium substrate. Alternatively, the electrostatic latent image corresponding to the image to be formed may be formed on a dielectric member, and the electrostatic latent image on the dielectric member may be transferred onto or brought closer to the surface of the medium substrate.

The above external electrostatic latent image forming devices, and particularly the device of forming the electrostatic latent image on the photoconductive member such as a photosensitive member can achieve such an advantage that the photoconductive member and others can be formed of common parts if the image forming portion for the normal image display medium is of the electrophotographic type and employs the photoconductive member such as a photosensitive member.

Image Forming Portion Utilizing Write Electrode

The image forming portion has an image write electrode arranged in contact with or close to the substrate of the image display medium, and applies a bias corresponding to the image to be displayed to the electrode.

For example, the image forming portion may have individual electrodes for respective pixels arranged in contact with or close to one (e.g., the substrate on the image observation side) of the substrates of the image display medium, and opposite electrodes arranged in contact with or close to the other substrate, and may be configured to apply a bias corresponding to the image to be displayed to each of the individual electrodes.

<Image Forming Portion for Reversible Image Display Medium of Magnetic Drive Type>

This image forming portion may have a magnetic head for image writing.

In either of the case where the image forming portion forms the image on the reversible image display medium of the electric field drive type and the case where it forms the image on the reversible image display medium of the magnetic drive type, an image erasing device may be employed for initializing the medium, or performing, as a kind of initialization, erasing of the last displayed image before the image display. A developer stirring device may be employed for initializing the medium, erasing the last displayed image before the image display, or improving the flowability of the developer particles (particularly, improving the flowability of the developer particles in the medium in the case of the dry chargeable particle containing type) for image display. Both the image erasing device and the developer stirring device may be employed.

The image erasing device may be, e. g., an erase electric field forming device for forming an electric field moving the developer particles forming the developer in the image display medium, a stirring device for applying a stirring force to the developer or a device including both of these devices. Application of the stirring force can be performed, e.g., by forming an alternating electric field with respect to the developer, forming an oscillating magnetic field, emitting ultrasonic waves, applying mechanical vibrations or a combination of two or more of them.

The erase electric field forming device may be a device for forming the electric field such that one of the two kinds of developer particles of the same optical reflection density (in other words, the same degree of contrast or the same color) are collected toward one of the substrates, and the other kind of developer particles of the same optical reflection density are collected toward the other substrate. According to this device, initialization of the medium as well as the image erasing can be performed, and further movement of the developer particles is required only in the image portion when forming a new image so that the image display can be performed smoothly and reliably with a high quality.

The erase electric field forming device may include a pair of electrodes or dielectric members arranged on the opposite sides of the reversible image display medium as well as a power supply device for applying a bias voltage thereto.

In addition to the above, the erase electric field forming device may be an electric field forming device of the discharging type for forming an electric field by performing discharging to the image display medium, or an electric field forming device of a charge injecting type for forming the electric field by injecting charges into the image display medium. A corona charging device, an electric field forming device of an ion-flow type and an electric field forming device of a multi-stylus type having a head, in which electrodes are arranged in a predetermined direction, are examples of the former. An electric field forming device of a multi-stylus type having a head, in which electrodes are arranged in a predetermined direction, and neighboring control electrodes are arranged adjacently to the above electrodes, is an example of the latter.

The stirring device may have the following structure.

(1) Device of Forming Alternating Electric Field for Reversible Image Display Medium

This device can be utilized in the case where at least one kind of developer particles has an insulating property.

(2) Device of Forming Oscillating Magnetic Field for Reversible Image Display Medium

This device can be utilized in the case where at least one kind of the developer particles contain magnetic members.

(3) Device of Emitting Ultrasonic Waves to Reversible Image Display Medium

(4) Device of Applying Mechanical Vibrations to Reversible Image Display Medium

(5) Device formed of a combination of two or more of the above devices.

Among them, the alternating electric field forming device and the oscillating magnetic field forming device are especially effective.

In the image forming apparatus, the first image forming portion for the normal image display medium and the second image forming portion for the reversible image display medium may be independent of each other, or may be partially common to each other. However, the heads for writing the image on the image display medium may be preferably independent of each other for each control of the heads.

Examples of the image forming apparatus and the method of controlling the image forming apparatus will now be described with reference to the drawings.

First, description will be given on the reversible image display medium.

<Reversible Image Display Medium of Dry Chargeable Particle Containing Type>

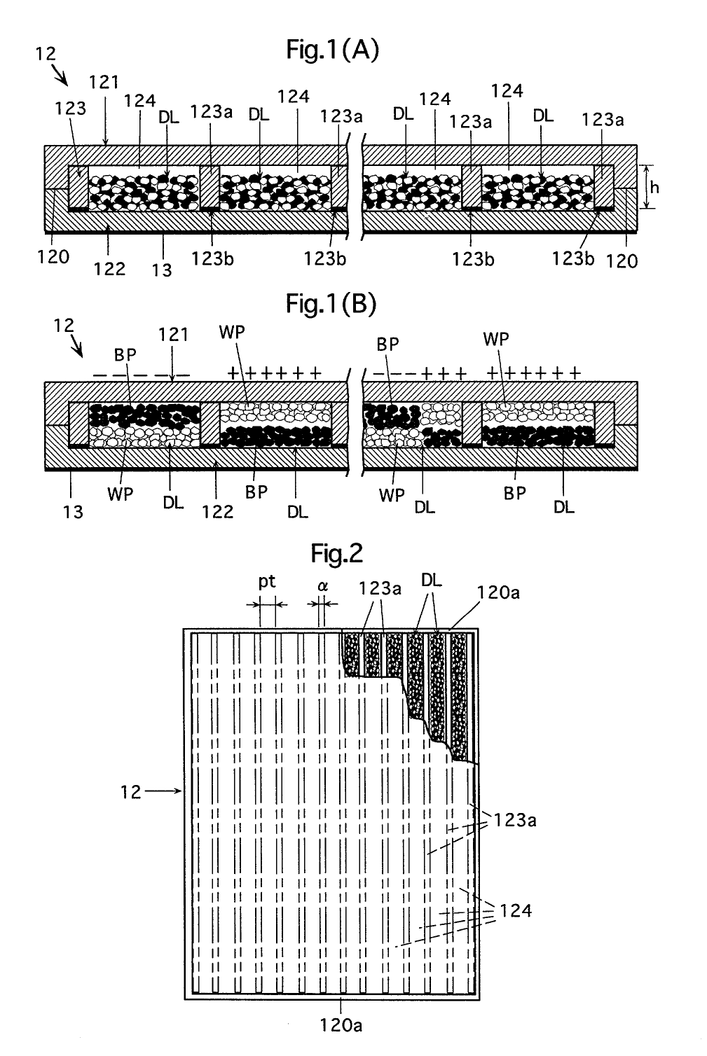

FIGS. 1(A), 1(B) and 2 show an example of a reversible image display medium of the dry chargeable particle containing type. FIG. 1(A) is a cross section of a reversible image display medium 12 before image display, and FIG. 1(B) is a cross section showing an example during the image display. FIG. 2 is a plan showing the medium 12 with a certain part cut away.

The image display medium 12 shown in these figures has a rectangular configuration, and includes first and second substrates 121 and 122 as well as a partition 123 located between these substrates. The first substrate 121 and the partition 123 are integral with each other, and are formed by thermal molding of transparent polyethylene terephthalate (PET). The second substrate 122 is also made of transparent PET, and has an outer surface coated with a vapor-deposited aluminum layer 13.

The partition 123 is formed of a plurality of longitudinal wall portions 123a, which are parallel to the longer side of the medium 12, and a developer accommodating cell 124 is formed by the neighboring wall portions 123a. Each cell 124 accommodates developer DL containing white and black developer particles WP and BP, which are mutually and frictionally charged.

The medium 12 is provided at its periphery with a thermally sealed portion 120 formed between the substrates 121 and 122. The seal portion 120 has portions 120a, which continue to the opposite ends of the longitudinal wall portions 123a and closes the opposite ends of the cells. These portions 120a also serve as partitions defining the cells 124.

Each cell is sealed so that developer DL does not leak from the cell.

The partition 123 (wall portions 123a) serves also as a spacer keeping a predetermined gap between the substrates 121 and 122.

The substrate 121 has an average thickness of 25 μm, and the substrate 122 likewise has a thickness of 25 μm. Each wall portion 123a has a width α of 20 μm and a height h of 100 μm, and is spaced from the neighboring wall portion by a distance pt of 200 μm. The developer DL is arranged within each cell 124 to fill 90% of its height before bonding the substrates-together, and then a thin layer of photo-setting adhesive 123b is applied over top surfaces of the longitudinal walls 123a on the substrate 121. The substrate 122 is closely attached thereto, and ultraviolet light is emitted for curing the adhesive. Further, the peripheries of the substrates are thermally sealed.

The developer particles and the developer in the cell are specifically as follows.

White Developer Particles WP

Thermoplastic polyester resin (softening point=121° C., glass transition point =67° C.) in an amount of 100 parts by weight, titanium oxide (manufactured by Ishihara Sangyo Co., Ltd., CR-50) in an amount of 40 parts by weight, and salicylic acid-zinc complex (minus-charge-controlling agent Bontron E-84, manufactured by Orient Chemical Co., Ltd.,) in an amount of 5 parts by weight were fully mixed by a Henschel mixer. The mixture thus prepared was kneaded by a 2-shaft extruder/kneader, and thereafter was cooled. Thereafter, the mixture was roughly pulverized, and then was finely pulverized by a jet mill. The resulting powder was classified with wind to produce white fine-grained powder having a volume average particle diameter of 10.1 μm. Thereafter, 0.3 parts by weight of hydrophobic silica particles (Nihon Aerosil Co., Ltd.: Aerosil R-972) is added to the above powder, and the mixing and kneading are performed by a Henschel mixer to produce the white developer particles WP.

Black Developer Particles BP

Styrene-n-butyl-methacrylate resin (softening point=132° C., glass transition point=65° C.) in an amount of 100 weight parts, carbon black (Lion Oil & Fat Co., LTD., Kechenblack EC) in an amount of 4 parts by weight, silica (Nihon Aerosil Co., Ltd.: #200) in an amount of 1.5 parts by weight and magnetite-containing magnetic powder (manufactured by Titan Kogyo Co., LTD., RB-BL) in an amount of 500 parts by weight were fully mixed by a Henschel mixer, and then were kneaded by a kneader and then cooled.

Thereafter, the mixture was roughly pulverized by a feather mill, and then was finely pulverized by a jet mill. The resulting powder was classified with wind to produce black particles BP having a volume average particle diameter of 25 μm.

Developer DL

The white particles WP and the black particles BP were put into a polyethylene bottle at a rate of 12 grams of the white particles and 88 grams of the black particles. The bottle was rotated by a ball mill pedestal to knead and mix the contents for 30 minutes so that the developer DL was obtained. The white particles were charged negatively, and the black particles were charged positively. The developer thus prepared was used.

The above medium 12 used in the embodiments will be referred to as “medium TP1” hereinafter.

<Reversible Image Display Medium of Electrophoresis Type>

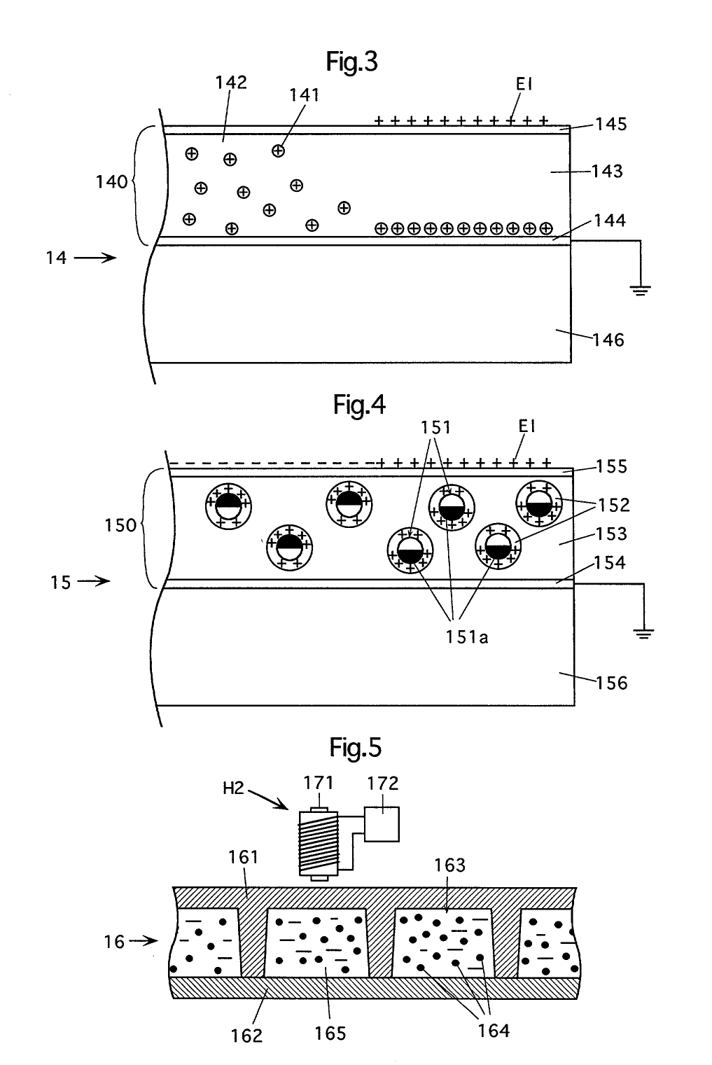

FIG. 3 shows an example of a structure of a reversible image display medium 14 of an electrophoresis type.

The medium 14 shown in FIG. 3 includes an electric field coloring layer 140 carried on a transparent carrier substrate 146. The electric field coloring layer 140 is formed of developer liquid 143, which includes charged and colored particles 141 dispersed in insulating liquid 142, and is sealingly held between a transparent conductive layer 144 and an insulating layer 145. The insulating liquid 142 is a mixture of high-purity petroleum (e.g., Isoper manufactured by Exxon Chemical Co., LTD.) as well as an ionic surface active agent and dyes. The organic particles 141 are mixed in the liquid 142 to complete the developer 143. The ionic surface active agent is adhered onto the organic colored particles 141 containing the pigment so that the particles are charged electrochemically stably. The charged and colored particles 141 are dispersed in the liquid 142 to exhibit an electrophoretic mobility.

When an electric field is not applied to the medium 14, or an electric field opposite to the predetermined electric field is applied to the medium 14, the dyes in the insulating liquid 142 can be externally viewed. When the electrostatic latent image is written, the charged and colored particles 141 move toward the transparent conductive layer 144 so that the colored particles can be externally viewed.

The image is displayed on the medium 14 by forming the electrostatic field corresponding to the image to be displayed with respect to the charged developer particles (charged and colored particles in this example) 141 dispersed in the insulating liquid 142.

<Reversible Image Display Medium of Twist Ball Type>

FIG. 4 shows an example of a structure of a reversible image display medium 15 of the twist ball type.

The medium 15 shown in FIG. 4 has an electric field coloring layer 150 carried on a transparent carrier substrate 156. The electric field coloring layer 150 includes one-side colored balls 151 each having a colored portion 151a on one side. The balls 151 are surrounded by insulating liquid 152, and are buried together with the liquid 152 in an insulation holding medium material 153. A transparent conductive layer 154 and an insulating layer 155 are formed on the opposite sides of the medium material 153, respectively.

The one-side colored ball 151 is prepared, e.g., in such a manner that white balls of glass primarily made of TiO₂ are uniformly arranged on an appropriate table, and chrome or the like is vapor-deposited thereto. The ball 151 may have a size from 30 μm to 100 μm. If it is equal to or smaller than 10 μm, the resolution of the image is further improved.

The one-side colored balls 151 are dispersed in the insulation holding medium material 153 such as elastomer, and the medium material 153 is swelled by immersing it in a solution prepared by dissolving an ionic surface active agent in organic solvent such as toluene. Thereby, the insulating liquid 152 is kept around the one-side colored ball 151. In this manner, the one-side colored ball 151 is surrounded by the insulating liquid layer 152, and is rotatably buried together with the liquid in the insulation holding medium material 153.

The one-side colored ball 151 has one and the other halves, which are different in properties, and therefore are different in amount of absorbable ions. By applying the electric field to the medium 15, the direction of the colored and uncolored surfaces of the one-side colored particle 151 changes depending on the direction of the electric field. Accordingly, the image is displayed by selectively and externally exhibiting the colored and uncolored surfaces of the one-side colored ball 151.

<Reversible Image Display Medium of Magnetic Drive Type>

FIG. 5 shows by way of example a structure of a reversible image display medium 16 of the magnetic drive type.

The medium 16 shown in FIG. 5 includes light absorbing black magnetic particles 164 and plastic dispersion 165, which contains a dispersion medium, and also contains, if desired, a thickner and a coloring agent. These particles 164 and the dispersion 165 are confined in each of small chambers 163 of the multi-cell structure sheet 160, which are formed by partitioning a space between two substrates 161 and 162. At least one of the two substrates 161 and 162 is transparent.

Instead of the medium of the above structure, the image display medium may have such a structure that the light absorbing black magnetic particles 164 and the plastic dispersion 165 similar to the above are confined in many micro-capsules, and a coating layer of these many micro-capsules is formed on one side of the transparent substrate.

According to these image display mediums, as shown in FIG. 5, a magnetic head H2 is used on the substrate surface of the substrate 161 on the front side (image observation side) to form predetermined magnetic fields for the respective pixels in accordance with the image to be formed. Thereby, magnetic particles 164 are attracted and moved by the magnetic force so that the image is displayed owing to contrast and difference in color between the plastic dispersion 165 and the magnetic particles 164.

The writing magnetic head H2 may have such a structure that includes a group of electromagnets 171, which are arranged for magnetically attracting the magnetic particles 164 within chambers 163 (or micro-capsules in the medium of the micro-capsule type) of the medium 16, toward the front substrate 161, and also includes a DC power source 172 for supplying a DC current to each electromagnet 171.

A coloring agent of the plastic dispersion 165 may be a white pigment or other pigments or dyes. The coloring agent may be added in amount of 10% or less, and preferably 3% or less to the plastic dispersion so that the contrast between the plastic dispersion liquid 165 and the magnetic particles 164 can be increased for clear image display.

The liquid absorbing black magnetic particles 164 are preferably made of magnetic material such as magnetite, ferrite or the like as well as a coloring agent such as carbon black and binder resin, which are kneaded and pulverized into particles having a particle diameter of about 5 μm-about 100 μm.

The light absorbing black magnetic particles 164 are added to the plastic dispersion 165 in amount of 5%-30% by weight, and more preferably, of 10%-20% by weight.

The dispersion medium forming the plastic dispersion 165 may be preferably isoparaffin solvent such as Isoper (manufactured by Exxon Chemical Co., Ltd.), a silicone oil or the like.

Several examples of the image forming apparatus and the method of displaying the information relating to the apparatus will now be described. In the following description:

the normal image display medium such as a normal paper sheet may be referred to as “medium PP” or

the reversible image display medium may be referred to as “medium TP” or “TP”.

The image formation mode for the normal image display medium such as normal paper sheet may be referred to as a “PP mode”, and

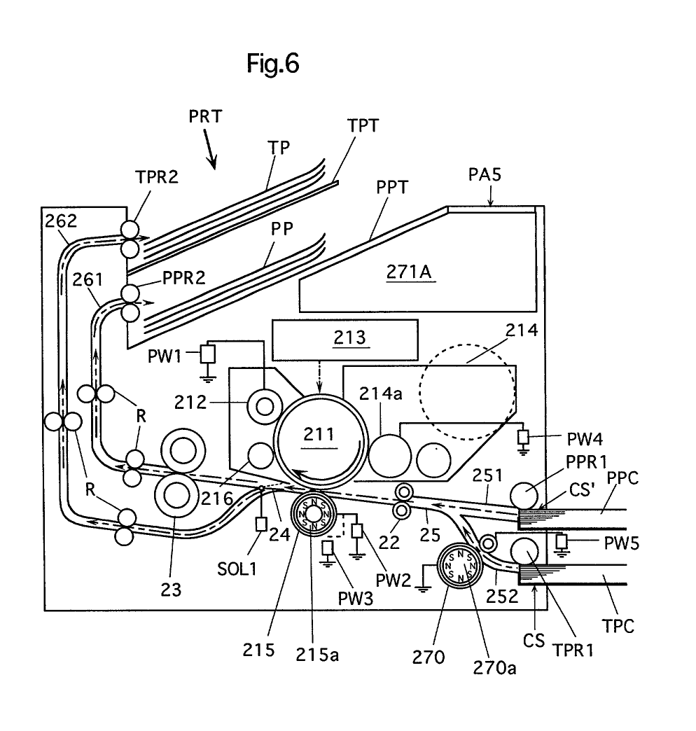

the image formation mode for the reversible image display medium may be referred to as a “TP mode”.

<Image Forming Apparatus (printer) PRT in FIG. 6>

An image forming apparatus PRT has a drum type photosensitive member 211, and also includes a charger (a charging roller in this example) 212, an image exposing device 213, a developing device 214, a transfer device (a transfer roller in this example) 215 and a cleaner (a cleaning roller in this example) 216.

The developing device 214 is a contact type one component developing device in this example, and has a developing roller 214a and accommodates a positive charging toner. The transfer roller 215 has a rotatable magnet roller 215a provided therein.

The photosensitive member 211 is rotated clockwise in FIG. 6 by a driving device which is not shown. The charging roller 212, the developing roller 214a, the transfer roller 215, and furthermore, the cleaning roller 216 and the magnet roller 215a can be rotated in a predetermined direction, respectively.

A voltage for charging the photosensitive member can be applied from a power source PW1 to the charging roller 212. The transfer roller 215 can be switched and connected to the power source PW2 or PW3 in accordance with an instruction of a control portion 271A which will be described below, and a transfer voltage at which a toner image on the photosensitive member is transferred onto the medium PP is applied from the power source PW2 and a bias voltage for forming an image on the medium TP is applied from the power source PW3. A developing bias is applied from a power source PW4 to the developing roller 214a.

The apparatus PRT further has a timing roller pair 22 on the upstream side of a nip portion between the photosensitive member 211 and the transfer roller 215, an eraser roller pair 270 on the upstream side thereof and upper and lower cassette attaching portions CS′ and CS. A cassette PPC for accommodating the medium PP (a normal paper sheet) can be removably attached to the upper cassette attaching portion CS′ and a cassette TPC for accommodating the medium TP can be removably attached to the lower cassette attaching portion CS.

A leading roller PPR1 for leading an image display medium one by one faces the cassette PPC to be attached and a leading roller TPR1 for leading the image display medium one by one faces the cassette TPC.

A medium type detecting device is provided in the cassette attaching portions CS′ and CS or in the vicinity thereof, which will be described below.

The image display medium led from the cassette PPC can reach the timing roller pair 22 through medium transporting paths 251 and 25.

The image display medium led from the cassette TPC can reach the timing roller pair 22 through medium transporting paths 252 and 25.

The eraser roller pair 270 to be rotated for the medium TP faces the path 252. A bias for image erase can be applied from a power source PW5 to one of the rollers (the upper roller in this example) of the eraser roller pair 270, and the other roller (the lower roller) is grounded. Moreover, a magnet roller 270a to be rotated is provided in at least one of the rollers (the lower roller in this example) of the roller pair 270.

The apparatus PRT further has a switching member 24 to lead the medium to the path 261 or 262, which is driven by a solenoid SOL1. The switching member 24 is provided on the downstream side of the nip portion between the photosensitive member 211 and the transfer roller 215. The path 261 for the medium PP extends from the member 24 to a discharge tray PPT through a fixing roller pair 23 and a discharge roller pair PPR2, and the path 262 for the medium TP makes a detour around the fixing device 23 and extends to a discharge tray TPT through a discharge roller pair TPR2. Medium guide roller pairs R are provided in proper positions on the paths 261 and 262.

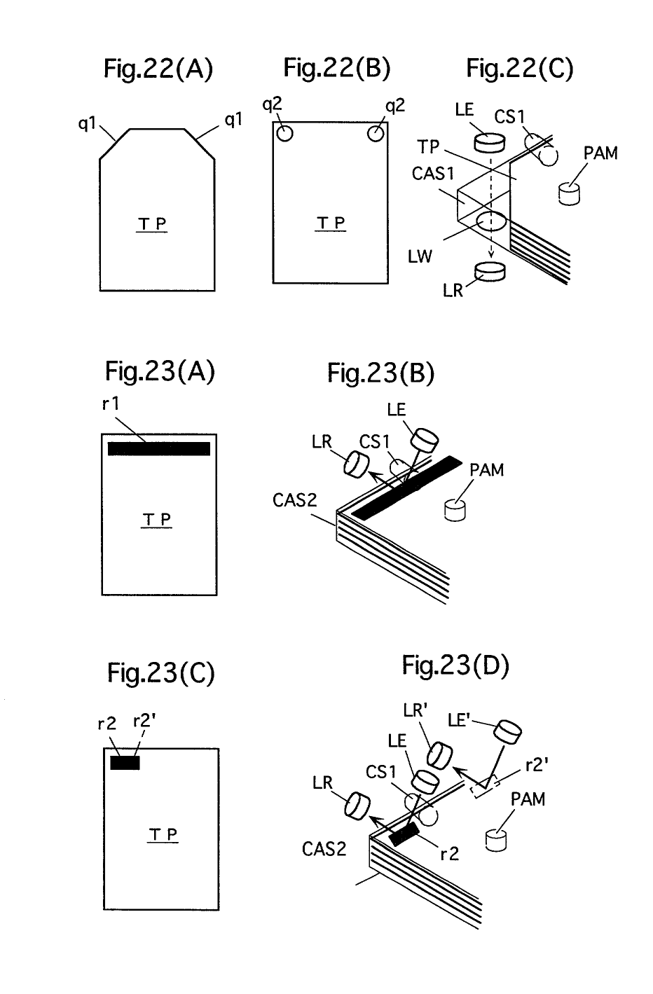

Furthermore, the control portion 271A for controlling the operation of the whole image forming apparatus is provided above the image exposing device 213, to which an operation panel PA5 is connected. The medium type detecting device provided in the apparatus PRT is one of those shown in FIGS. 22(A) to 22(C), FIGS. 23(A) to 23(D), FIGS. 24(A) and 24(B), and FIGS. 25(A) and 25(B) or others which will be described below.

The medium type detecting device shown in FIGS. 22(A) to 22(C) includes a cassette CAS1 capable of accommodating either the medium PP or the medium TP which is provided with a light transmission window LW in a corner portion on the bottom thereof, and a light emitting element LE and a light receiving element LR which are positioned above and below the light transmission window LW when the cassette is attached to the image forming apparatus body as shown in FIG. 22(C).

When the medium TP having a cut corner portion ql as shown in FIG. 22(A) or provided with a transmission hole q2 in the corner portion as shown in FIG. 22 (B) is accommodated in the cassette and the cassette is attached in the apparatus body, the cut corner portion q1 or the transmission hole q2 portion in the medium faces the light emitting element and the light receiving element so that light transmitted from the light emitting element LE is detected by the light receiving element LR and the medium TP can be detected.

On the other hand, when the medium PP having no cut corner portion or having no transmission hole is accommodated in the cassette CAS1 and the cassette CAS1 is attached to the apparatus body, the light transmitted from the light emitting element LE cannot be detected by the light receiving element LR so that the medium PP is detected.

The cassette attaching portion of the image forming apparatus body is provided with a cassette sensor CS1 for detecting the presence of the cassette and a sensor PAM for detecting the presence of the image display medium in the cassette attached to the apparatus body. This respect is the same also when the following medium type detecting device is to be employed.

The medium type detecting device shown in FIGS. 23(A) to 23(D) includes a light emitting element LE and a light receiving element LR and furthermore a light emitting element LE′ and a light receiving element LR′ which are opposed to the medium accommodated in a cassette CAS2 capable of accommodating either the medium PP or the medium TP when the cassette CAS2 is attached to the image forming apparatus body as shown in FIGS. 23(B) and 23(D).

When the medium TP provided with a light reflecting surface r1 at its end as shown in FIG. 23(A) or the medium TP provided with a light reflecting surface r2 indicative of the surface side (front side) at its end as shown in FIG. 23(C) is accommodated in the cassette and the cassette is housed in the apparatus body, the light emitted from the light emitting element LE is reflected by the reflecting surface r1 or r2 of the medium and is received by the light receiving element LR. Consequently, the medium TP can be detected. In FIGS. 23(C) and 23(D), the surface side (front side) of the medium TP can be also detected.

In FIGS. 23(C) and 23(D), when the medium TP is turned over (located up side down) and accommodated in the cassette, a light reflecting surface r2′ on the back side of the medium TP is detected by the light emitting element LE′ and the light receiving element LR′. Consequently, the medium TP can be detected and it is also detected that the medium TP has a back side out.

When the medium PP having no reflecting surfaces r1, r2 and r2′ is accommodated in the cassette CAS2 and the cassette CAS2 is attached to the apparatus body, the light transmitted from the light emitting elements LE and LE′ cannot be detected by the light receiving elements LR and LR′ or the light can be detected in a small quantity. Consequently, the medium PP can be detected.

The medium type detecting device shown in FIGS. 23(A) to 23(D) can detect the medium PP and the medium TP even if they are accommodated together in the cassette CAS2.

In place of the light reflecting surfaces r1, r2 and r2′, the medium PP and the medium TP may have electrostatic capacities, surface resistances and quantities of magnetism or the like which are different from each other. By detecting them, the medium PP and the medium TP may be distinguished from each other.

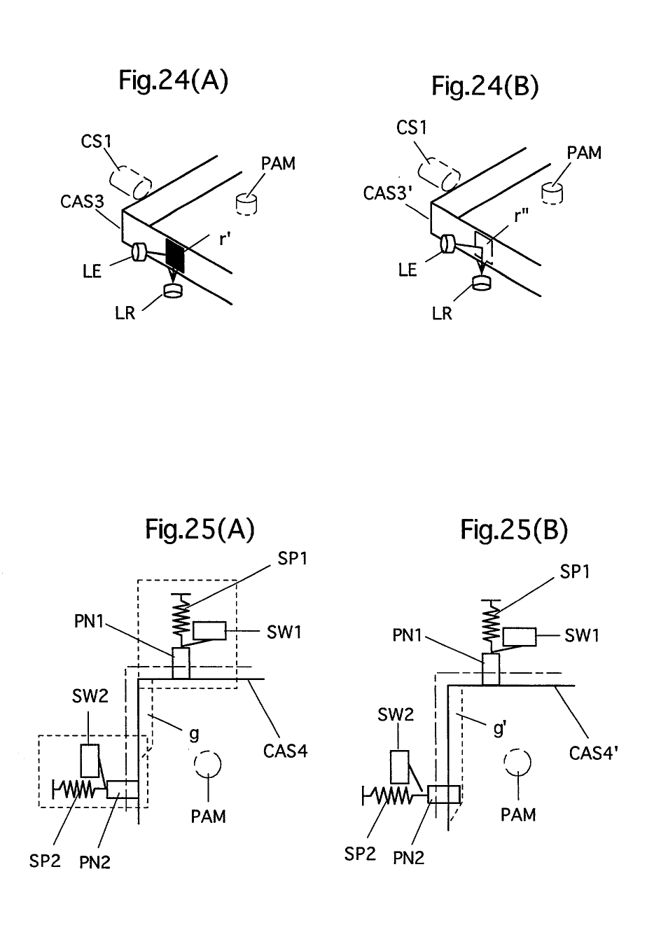

The medium type detecting device shown in FIGS. 24(A) and 24(B) includes a cassette CAS3 for accommodating the medium TP which has a low reflection density surface r′ provided on a side surface thereof, a cassette CAS3′ for accommodating the medium PP which has a high reflection density surface r″ provided on a side surface thereof, a cassette sensor CS1 for detecting the attachment of the cassette when the cassette is attached to the apparatus body, and a light emitting element LE and a light receiving element LR which faces the reflecting surface r′ or r″ of the attached cassette as shown in FIGS. 24(A) and 24(B).

When the cassette CAS3 is attached, the cassette sensor CS1 detects the attachment thereof and the light emitting element LE and the light receiving element LR detect the low reflection density surface r′. Consequently, the medium TP can be detected.

When the cassette CAS3′ is attached, the cassette sensor CS1 detects the attachment thereof and the light emitting element LE and the light receiving element LR detect the high reflection density surface r″. Consequently, the medium PP can be detected.

The reflecting surface r′ may be the high reflection density surface and the reflecting surface r″ may be the low reflection density surface.

A medium type detecting device shown in FIGS. 25(A) and 25(B) includes two sets of sensors, which are arranged on the cassette attaching portions of the image forming apparatus body, and more specifically includes:

a sensor formed of a pin PN1, which can be pushed by a front end surface of the cassette while it is being attached, and thereby is retreated against a spring SP1, and a switch SW1 activated by the retreating pin PN1, and

a sensor formed of a pin PN2 which is fitted to a groove g arranged on the side surface of the cassette while it is being attached, is pushed back against a spring SP2 to activate the switch SW2 by the side portion of the cassette not provided with the groove g if the groove g is short because it is formed in the cassette CAS4 accommodating the medium TP, and does not move backward from the position fitted into a groove g′ if the groove g′ is arranged in the cassette CAS4′ for accommodating the medium PP, and thus is long.

When both the switches SW1 and SW2 are activated, it is determined that the mediums TP are to be handled. When only the switch SW1 is activated, it is determined that the mediums PP are to be handled.

In the image forming apparatus PRT, the cassette PPC accommodating the medium PP is attached in the cassette attaching portion CS′. The cassette PPC is the cassette CAS1 or CAS2 accommodating the medium PP or the cassette CAS3′ or CAS4′ which is special for the medium PP.

Moreover, the cassette TPC is attached to the cassette attaching portion CS on the underside. The cassette TPC is the cassette CAS1 or CAS2 accommodating the medium TP or the cassette CAS3 or CAS4 which is special for the medium TP.

Any of the medium type detecting devices is provided on each of the cassette attaching portions CS and CS′ if necessary.

Both an operation for forming an image on the medium PP and an operation for forming an image on the medium TP are controlled by the control portion 271A for controlling the operation of the whole apparatus PRT.

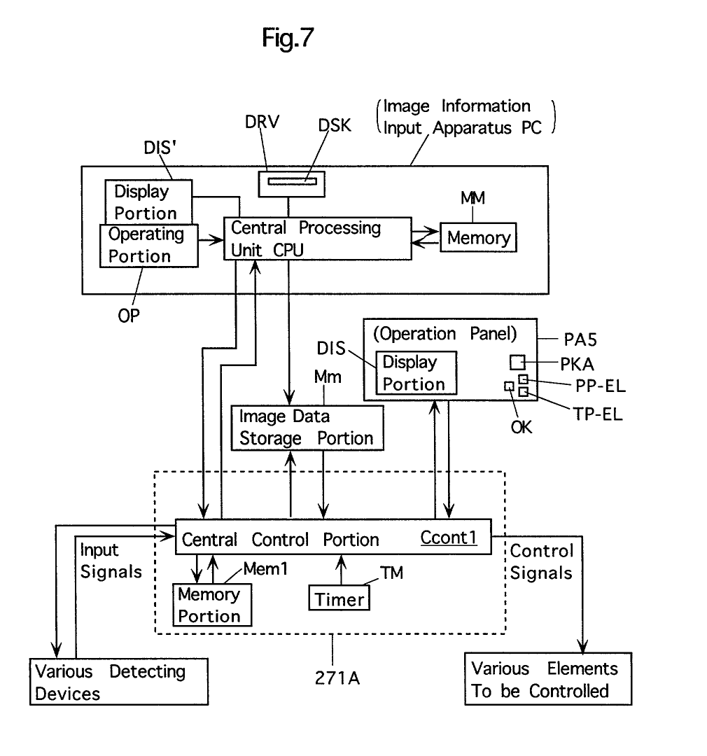

FIG. 7 is a block diagram schematically showing a control circuit of the image forming apparatus (printer) PRT.

As shown in FIG. 7, the control portion 271A in the apparatus PRT includes a central control portion Ccont1, and furthermore, a memory portion Mem1 for storing a program for controlling the operation of the apparatus and various set data necessary for executing the program, an internal timer TM for generating timings of various element operations and the like which are connected to the central control portion.

In to the central control portion Ccont1, information can be input from various detecting devices and the like, for example, timing detection signals sent through an input port (not shown) from a pre-regist sensor which will be described below, a medium discharge sensor or the like, a temperature detection signal sent from a temperature detecting sensor in the fixing roller pair 23, a medium type detection signal sent from the medium type detecting device, a medium state (the directions of a surface and a back face (back side) or the like) signal, a medium presence detection signal sent from a sensor PAM (see FIG. 25(C) and others), and the like.

The image data storage portion Mm, the operation panel PA5 and various elements to be operatively controlled are connected to the central control portion Ccont1. Control signals are output to the various elements.

The image data storage portion Mm serves to once store image data transferred from the image information input apparatus PC such as a personal computer, a facsimile receiver or a print server.

The various elements to be operatively controlled may be the rotary drive portion of the photosensitive member 211, the rotary drive portion of the charging roller 212 and the power source PW1 connected to the roller 212, the image exposing device 213, the driving portion of the developing device 214 and the developing bias power source PW4, the driving portion of the transfer roller 215 and the transfer power source PW2 connected to the roller 215, the driving portion of the magnet roller 215a, the driving portion of the medium leading or supplying rollers PPRl and TPR1, the driving portion of the eraser roller pair 270 and the power source PW5, the driving portion of the solenoid SOL1 for the switching member 24, the driving portion of the fixing roller pair 23, the driving portion of the discharge rollers PPR2 and TPR2, portions related thereto and the like.

The operation panel PA5 is provided with a key PKA for indicating an image formation start, a display portion DIS, a lamp PP-EL for giving a notice of the presence of a medium in the cassette PPC, a lamp TP-EL for giving a notice of the presence of a medium in the cassette TPC, a lamp OK indicating that print can be allowed, and the like.

The image information input apparatus PC connected to the image forming apparatus PRT has a central processing unit CPU to which a memory MM, an operating portion OP such as a keyboard, a display portion DIS′, a drive DRV of a recording medium DSK and the like are connected.

An image output command can be sent from the central processing unit CPU of the image information input apparatus PC to the central control portion Ccont 1 and image data can be transferred to the image data storage portion Mm and can be once stored in the storage portion Mm.

The central control portion Ccont1 gives an instruction for image formation on a medium based on the data thus stored in the image data storage portion Mm.

The recording disk DSK is an example of the computer readable recording medium and stores a program for executing various controls which are described later.

Next, description will be given to an example of the image formation in the PP mode using the normal paper sheet and the image formation in the TP mode using the medium TP1 in the image forming apparatus mentioned above.

PP Mode (Image Formation on a Plain Normal Paper Sheet through an Electrophotographic Method)

The medium PP (normal paper sheet) accommodated in the cassette PPC is led from the cassette by the leading roller PPR1, is delivered to the timing roller pair 22 and is caused to hit on the nip portion thereof. At this time, the leading end of the medium PP is detected by a pre-regist sensor which is not shown and a timing of the transfer of a toner image on the photosensitive member for the medium PP is taken.

The surface of the photosensitive member 211 is charged to +500 V by the charging roller 212, an image is exposed onto the charged area by the image exposing device 213, and an electrostatic latent image corresponding to the image to be formed is formed. The surface potential of the exposed portion is attenuated to the vicinity of 0 V and the portion other than the above is maintained to be +500 V.

The electrostatic latent image reaches the developing device 214 and a developing bias of +400 V is applied from the power source PW4 to the developing roller 214a.

Accordingly, the electrostatic latent image formed on the photosensitive member 211 is developed with the toner into a visible image by the electric field formed between the electrostatic latent image and the developing roller 214a. In other words, only the exposed portion is developed.

Next, the toner image on the photosensitive member is transferred by the transfer roller 215 onto the medium PP sent in synchronization with the toner image on the photosensitive member from the timing roller pair 22. At this time, a bias of −1000 V is applied to the transfer roller 215 and the positively chargeable toner is electrostatically transferred from the photosensitive member onto the medium PP.

Then, the photosensitive member 211 is cleaned by the cleaning roller 216 so that the toner remaining on the photosensitive member 211 is removed, the surface potential is initialized again by the charging roller 212 for the next image formation.

The medium PP having the toner image transferred thereto passes through the fixing roller pair 23 so that the toner image is fixed onto the medium under heat and pressure, and the medium PP is then discharged to the tray PPT.

TP Mode (Using the Medium TP1)

The medium TP1 accommodated in the cassette TPC is led from the cassette by the leading roller TPR1, is delivered to the timing roller pair 22 through the eraser roller pair 270 and is caused to hit on the nip portion thereof. At this time, the leading end of the medium TP1 is detected by the pre-regist sensor which is not shown and a timing of the image write to the medium TP1 is taken.

The eraser roller pair 270 to which a bias voltage of +250 V is applied from the power source PW5 moves white developer particles in the medium TP1 to one of the substrates and black developer particles to the other substrate, thereby initialization of the medium TP1 (which is also erased when the image is already formed) is performed, and furthermore, the rotating magnet roller 270a gives an oscillating magnetic field to the developer containing magnetic particles included in the medium TP1 and stirs the same developer, thereby enhancing the fluidity of the developing particles and making the initialization of the medium TP1 easy.

The eraser roller pair 270 may be provided on the upstream side or downstream side of the timing roller pair 22. One roller pair may serve as the eraser roller pair and the timing roller pair.

The surface of the photosensitive member 211 is charged to +500 V by the charging roller 212, an image is exposed onto the charged area by the image exposing device 213, and an electrostatic latent image corresponding to the image to be formed is formed.

Next, the electrostatic latent image is opposed to the medium TP1 sent from the timing roller pair 22 and a contrast image corresponding to the electrostatic latent image on the photosensitive member is formed on the medium TP1 by the transfer roller (acting as a counter electrode, in this case) 215 to which a bias for image writing is applied from the power source PW3.

At this time, the developing device is caused to retreat by a developing device retreating mechanism which is not shown. However, the developing device does not need to retreat depending on the type thereof. If the development is not carried out with the toner and the electrostatic latent image can be prevented from being disturbed, such developing device may be employed.

A peripheral speed ratio (θ) of a circumferential speed of the photosensitive member to that of the transfer roller (the counter electrode roller) is set to be constant with θ=1 and a bias of +250 V is applied to the transfer roller to form the image by Coulomb force acting between an electrostatic field formed in the region where the photosensitive member is opposed to the transfer roller (the counter electrode roller) and the charged developing particles included in the medium TP1. In the image formation, moreover, the magnet roller 215a provided in the transfer roller 215 is rotated and the developing particles in the medium TP1 are magnetically stirred to enhance the fluidity thereof. In this state, the image is formed.

Thus, the medium TP1 having an image formed thereon is discharged to the tray TPT by the passage 262.

The trays PPT and TPT may be identical to each other.

Although, the medium TP1 is caused to make a detour around the fixing device 23 in the image forming apparatus, the medium TP1 may be caused to pass through the fixing device 23 portion and the fixing device 23 may be caused to retreat at that time such that the medium TP1 is not adversely affected.

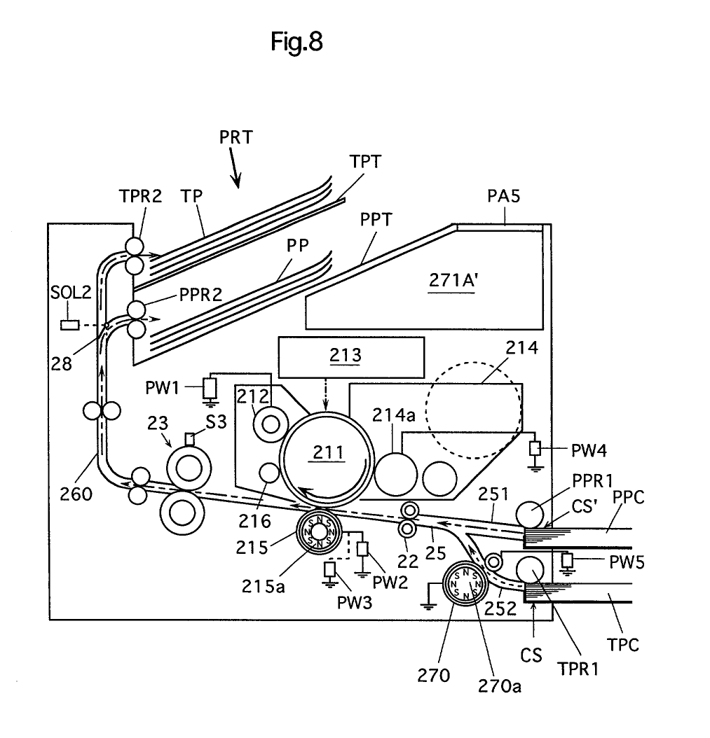

Furthermore, the image forming apparatus PRT may be provided with an electric charge eraser for erasing electric charges remaining on the photosensitive member 212 prior to the charging carried out by the charging roller 212 after the toner image is transferred onto the medium PP or the image is written to the medium TP. This respect is the same in image forming apparatuses which will be described below.

<Image Forming Apparatus (Printer) PRT in FIG. 8>

An image forming apparatus shown in FIG. 8 differs from the apparatus shown in FIG. 6 in that either of the medium PP and the medium TP having an image formed thereon passes through the fixing device 23 portion toward the tray PPT or TPT via the transporting path 260 provided with a switching member 28 driven by a solenoid SOL 2. Moreover, a sensor S3 for detecting the temperature of the fixing device is provided and information about the temperature is input to the control portion 271A′.

The control portion 271A′ has basically the same structure as that of the control portion 271A in the image forming apparatus in FIG. 6 and the image forming apparatus in FIG. 8 operates based on the instruction of the control portion 271A′. An operation panel PA5 is connected to the control portion 271A′ and the same image information input apparatus PC as that shown in FIG. 6 is connected thereto.

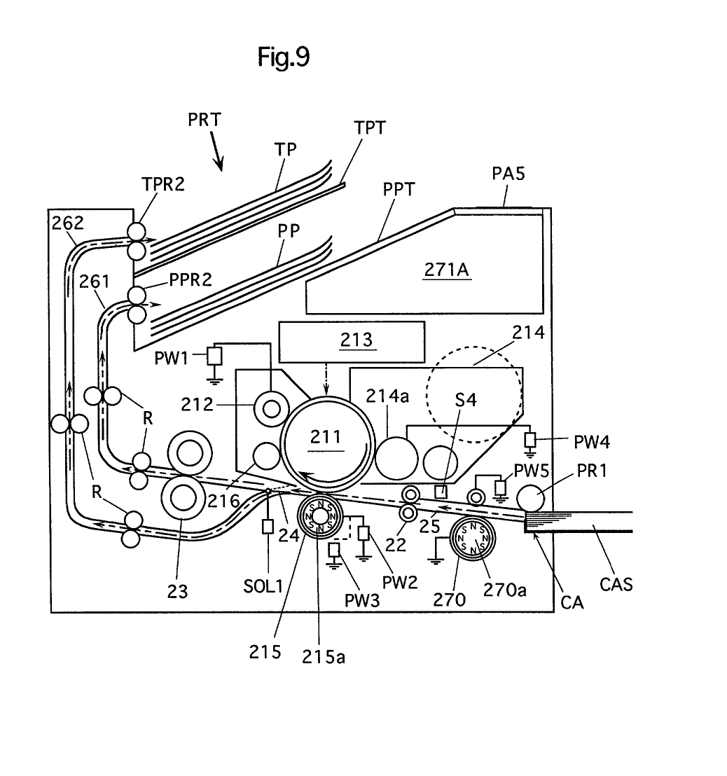

Other structures are the same as those of the apparatus shown in FIG. 6 and the same parts have the same reference numerals.

<Image Forming Apparatus (Printer) PRT in FIG. 9>

An image forming apparatus PRT shown in FIG. 9 differs from the apparatus shown in FIG. 6 in that only one cassette attaching portion CS followed by the eraser roller pair 270 is used and a cassette CAS is attached thereto.

A medium type detecting sensor S4 is provided on the slightly upstream side of the timing roller pair 22.

Other structures are the same as those of the apparatus shown in FIG. 6 and the same parts and parts having basically the same structures take the same reference numerals.

Next, description will be given to the specific examples of the detection of the state(s) in the image forming apparatus (printer) PRT and the setting state(s) in the image forming apparatus PRT and job control. In order to avoid complication, it is assumed that all the results of the detection other than the described detection are normal.

In flow charts showing the control operation of the control portion of the image forming apparatus and (or) the control portion of the image information input apparatus which will be referred in the following description, the image formation is displayed as “printing” or “print” and the image forming apparatus PRT is displayed as a printer. The image information input apparatus PC is displayed as an “image input apparatus” or an “image input portion” in some cases. A personal computer is displayed as PC.

In some cases, moreover, the medium is displayed as a “paper”.

### EXAMPLE 1

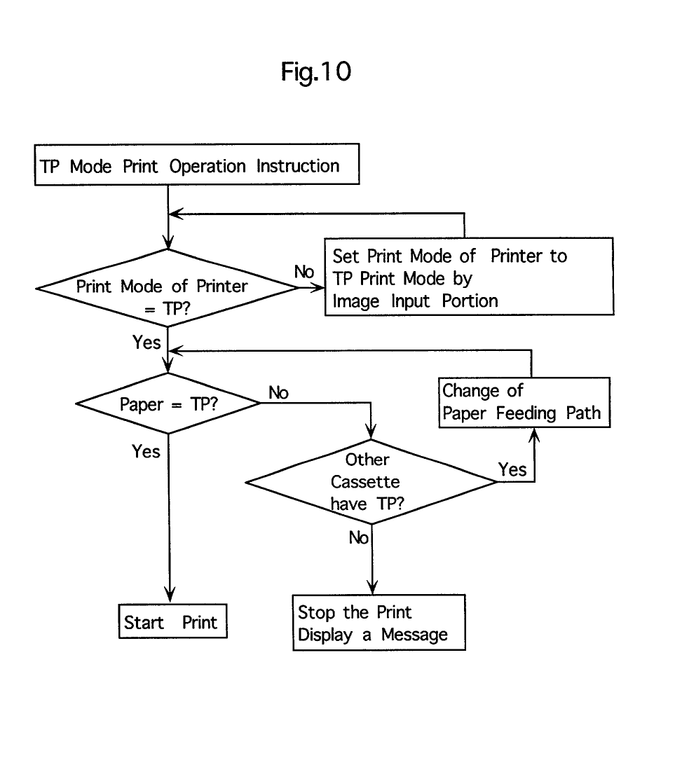

The image forming apparatus (printer) PRT shown in FIG. 6 is used. A controlling method in which a print operation instruction is “TP mode print” (TP print) will be described with reference to a flow chart shown in FIG. 10.

When the print operation instruction of “TP print” is transmitted from the image information input apparatus to the printer PRT, the printer transmits, to the image information input apparatus, a result of detection indicating whether the print mode of the printer is the “TP print mode” or not. If the print mode is the “TP print”, a medium type is consecutively detected. If the print mode of the printer is not the “TP print”, the image information input apparatus transmits an instruction of change into the TP print mode. When the change into the “TP print mode” is completed, the medium type (paper type) is detected.

If the medium is not the medium TP as a result of the detection of the paper type, other paper feeding portions (other medium cassettes) are detected to decide whether the medium TP can be fed or not. If the medium TP cannot be fed, the print is stopped. Moreover, a message such as an alarm may be displayed.

If the medium TP can be fed, the image data are transmitted from the image information input apparatus. The image data are optimized for the TP print. For example, monochrome having four gradations and 300 dpi or the like is used.

The medium type is detected on the cassette side by one of the medium type detecting devices described above. Alternatively, a sign corresponding to the medium may be provided at a cassette. For example, a cassette for the medium PP is provided with a hole in a portion which is in contact with the apparatus body and a cassette for the medium TP is not provided with a hole. In this case, the portion having a hole or no hole can be detected by a pressure sensor provided in the apparatus body to determine the medium type.

It is also possible that a user operates a medium (paper) setting switch provided on the cassette to detect the same portion.

### EXAMPLE 2

The example 2 is the same as the example 1 except that the medium type detection is carried out through test printing.

In this case, a display control operation is the same as that in FIG. 10.

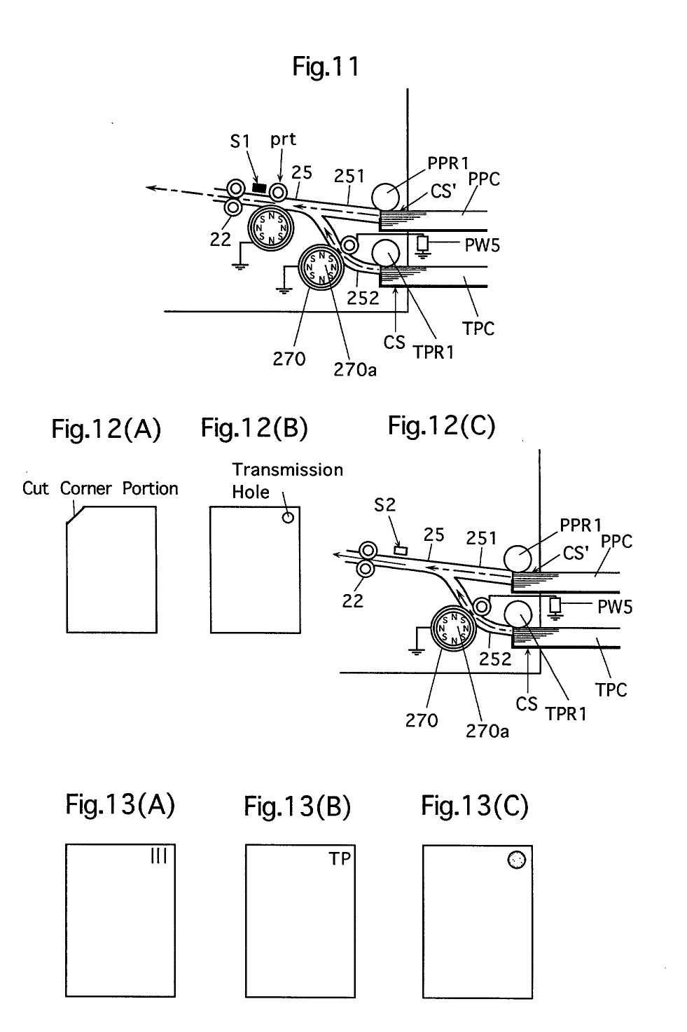

As a detecting method, as shown in FIG. 11, a test printing mechanism prt may be used, which is provided on the slightly upstream side of the timing roller pair 22 to print a test pattern on the medium and to discriminate the pattern by a detecting sensor S1 such as an optical sensor in the apparatus PRT.

The test pattern can be printed on the medium TP and nothing is printed on the medium PP. Consequently, a medium type can be detected by the sensor S1.

In this case, a combination with medium type detection in the cassette may be employed.

### EXAMPLE 3

The example 3 is the same as the example 2 except that the medium type detection is carried out based on the shape of the medium or the like. Any shape of the medium can be used if at least one of a size, a shape and the like is different from that of the medium PP so that a medium type can be detected.

In an example shown in FIG. 12(A), a corner portion of the medium TP is cut. In an example shown in FIG. 12(B), the corner portion of the medium TP is provided with a transmission hole. These are detected by an optical sensor S2 provided on the slightly upstream side of the timing roller pair 22 as shown in FIG. 12(C).

Moreover, if it is detected that the medium is PP, the medium PP is forcibly discharged and other cassettes are detected.

### EXAMPLE 4

The Example 4 is the same as the example 3 except that medium type detection is carried out using a mark or sign formed on the medium, which can be detected by a sensor.

The detection can be carried out in the same manner as that in the example 3.

As the mark and the sign, character information, a pattern image and the like can be optionally used as shown in FIGS. 13(A) to 13(C). Such mark, sign or the like may be positioned on a part of the medium or the whole medium.

### EXAMPLE 5

The example 5 is the same as the example 2 except that the surface and back face of the medium TP are detected through test printing.

Medium type detection is carried out in the same manner as that in the example 1, and the medium TP is supplied.

The surface and back face of the medium TP are detected in the same manner as the medium type detection to be carried out by the test printing mechanism in the example 2. If the print test pattern is detected in the test printing mechanism, the medium TP is oriented normally. If not so, it is decided that the direction of the medium TP has the back face out or the medium is set by mistake.

### EXAMPLE 6

The apparatus PRT shown in FIG. 8 is used.

The example 6 is the same as the example 2 except that the temperature of the fixing device is detected in place of the medium type detection.

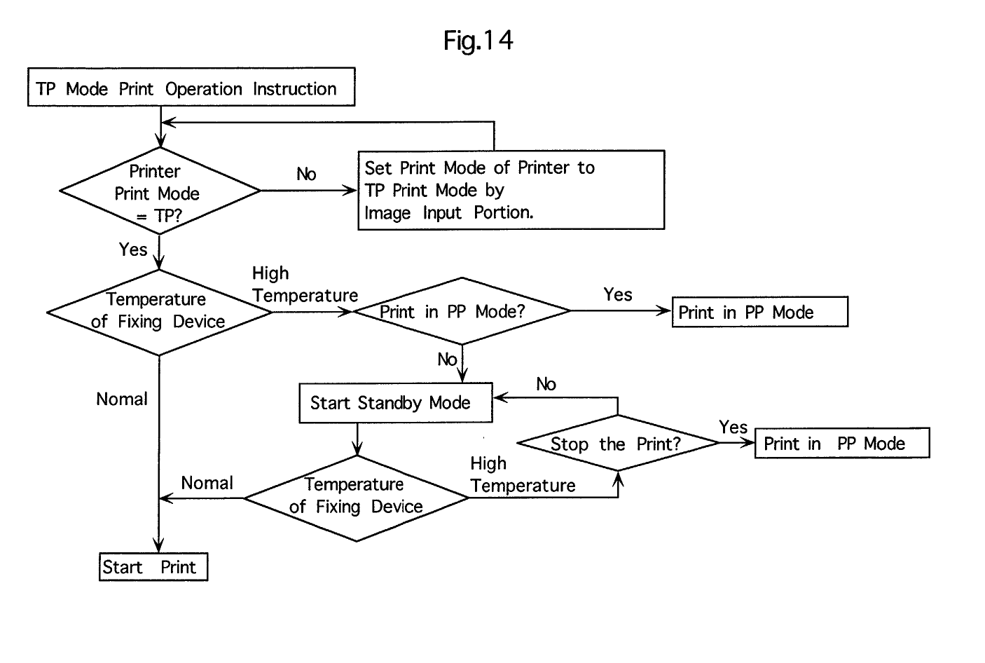

FIG. 14 is a flow chart showing a control operation to be carried out in this case.

A print mode is confirmed and changed in response to a print instruction. The temperature of the fixing device is detected. If the temperature of the fixing device is normal for the TP mode, print is carried out. If the temperature of the fixing device is high, a user is requested to ascertain whether or not the print is to be carried out in the PP mode. If Yes, the medium PP is printed. If No, a standby mode is started to wait for a normal temperature.

When the temperature of the fixing device becomes normal, the print is carried out in the TP mode. When the user selects the stop of the print during the standby, the print is stopped.

### EXAMPLE 7

The example 7 is the same as the example 1 except that the apparatus PRT having one cassette attaching portion shown in FIG. 9 is used.

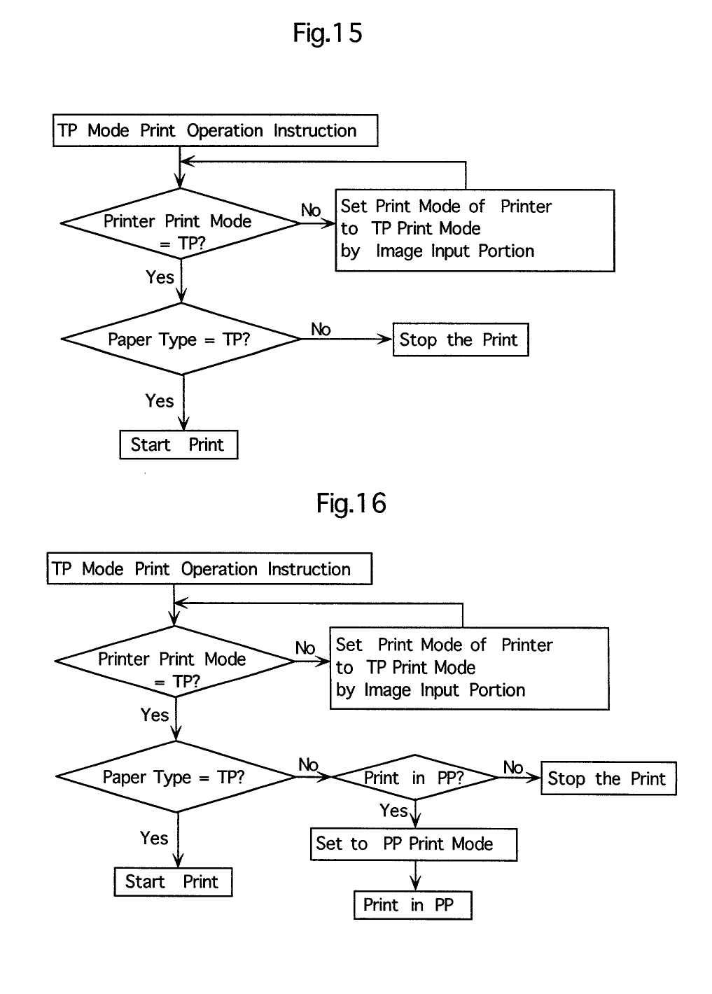

FIG. 15 is a flow chart showing a control operation to be carried out in this case.

The print mode of the printer is set to the TP mode in response to a print instruction given to the medium TP. Then, a medium type is detected by the medium type detecting sensor S4. If the medium type is the medium TP, the print is started. On the other hand, if an error is detected, the print is stopped.

As shown in FIG. 16, if the medium type is different, switching into the PP mode may be carried out.

### EXAMPLE 8

For example, the apparatus PRT shown in FIG. 6 is used. In this example, a user does not specify a print mode but the change of a print mode can be carried out by a printer driver based on the image data to be printed.

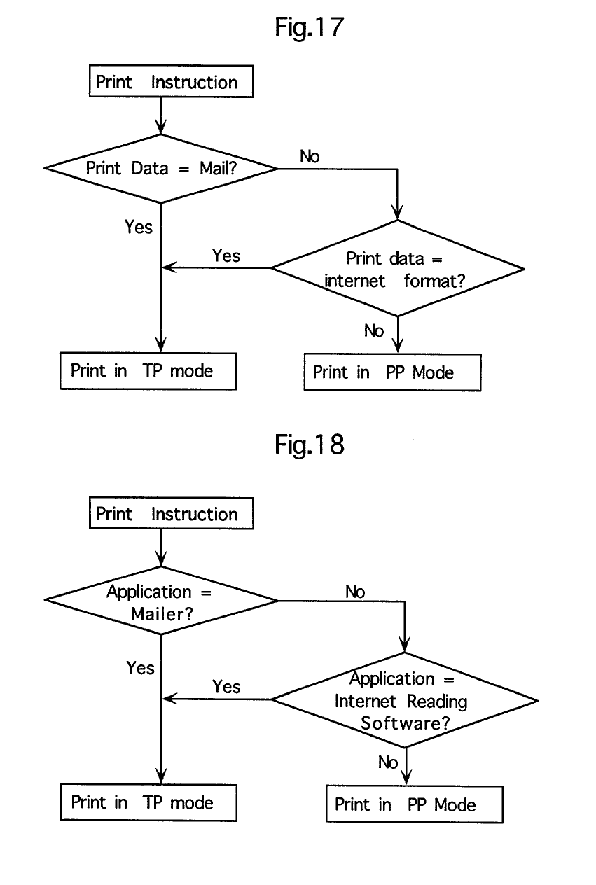

FIG. 17 is a flow chart showing a control operation to be carried out in this case.

When the user does not specify the print mode but instructs the print, the printer driver detects the image data and first search the presence of a mail header such as “From:”, “To:” or “Message-ID:”. As a result, when it is detected that the image data is a mail data, the print is carried out in the TP mode.

If the image data are not the mail data, a style peculiar to an html document such as “http” or “WWW” is then searched and it is decided whether the html document is present or not.

### EXAMPLE 9

For example, the apparatus PRT shown in FIG. 6 is used. In this example, a user does not specify a print mode but the print mode can be set by a printer driver based on an application software receiving a print instruction or a print setting of the application software.

FIG. 18 is a flow chart showing a control operation to be carried out in this case.

When the user does not specify the print mode but instructs the print, the printer driver detects the application software receiving the print instruction or the print setting of the application software. As a result, when the printer driver detects that the application software is a mailer or an html reading software, print is carried out in the TP mode. If not so, the print is carried out in the PP mode.

### EXAMPLE 10

For example, the apparatus PRT shown in FIG. 6 is used. In this example, a user does not specify a print mode but the print mode is set by the printer based on the result of detection of a type of the image information input apparatus from which the print image data is transmitted to the printer.

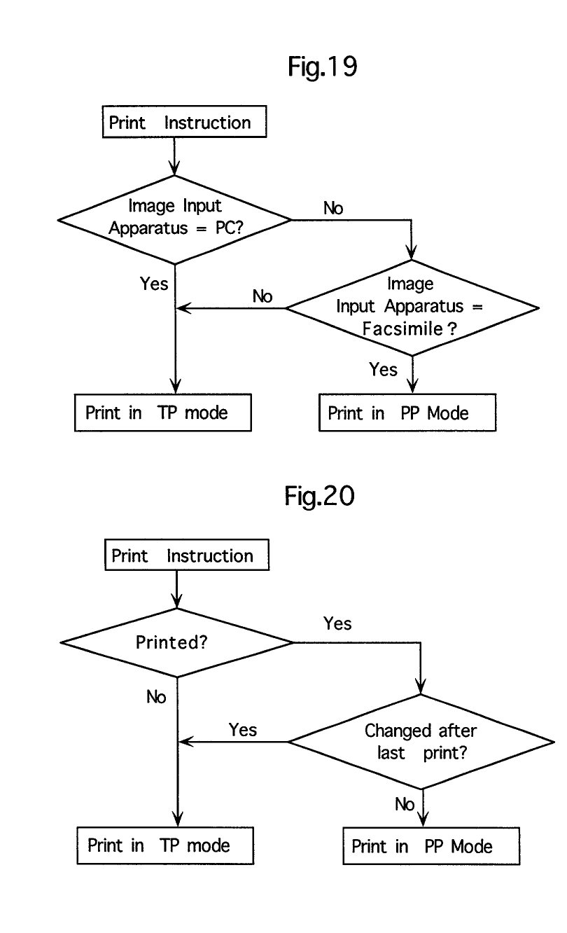

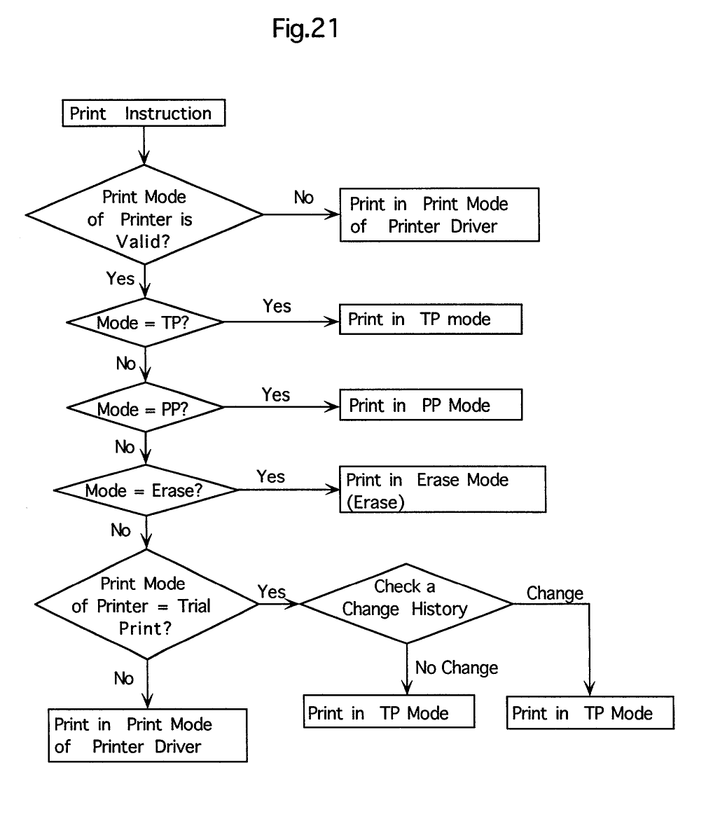

FIG. 19 is a flow chart showing a control operation to be carried out in this case. In FIG. 19, “PC” indicates a personal computer.

### EXAMPLE 11

For example, the apparatus PRT shown in FIG. 6 is used. In this example, a user does not specify a print mode but a change history of data is detected.

FIG. 20 is a flow chart showing a control operation to be carried out in this case.

An application software or a printer driver detects the presence of a changed history after the last print over a change history file. Alternatively, a key input carried out after the last printing may be monitored.

As a result of the detection, the print is carried out in the TP mode if there is a change, and the print is carried out in the PP mode if there is no change.

### EXAMPLE 12

For example, in the apparatus PRT shown in FIG. 6, the print mode of a printer is valid and a user does not specify the print mode but carries out print.

In response to a print instruction, it is detected that the print mode of the printer is valid or not. If the print mode is invalid, the print is carried out in the print mode of the printer driver. The print mode is detected if it is valid, and the print is carried out in the same mode. In the case of other print modes which are not supported, the print is carried out according to the setting of the print driver of the printer.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A method of controlling an image forming apparatus having a first image forming portion for forming an image on a normal image display medium and a second image forming portion for forming an image on a reversible image display medium and capable of forming an image on the normal image display medium by the first image forming portion and of forming an image on the reversible image display medium by the second image forming portion, comprising the steps of:
transmitting at least part of information about the image forming apparatus to an image information input apparatus for transmitting image data to the image forming apparatus; and
carrying out, based on at least one of the information to be transmitted from the image forming apparatus to the image information input apparatus and information about the image information input apparatus, at least one of (1) selection of a method of processing the image data to be transmitted to the image forming apparatus in the image information input apparatus, (2) change of a state of the image forming apparatus in the image information input apparatus, and (3) change of a state of the image forming apparatus in the image forming apparatus.

2. A method of controlling an image forming apparatus having a first image forming portion for forming an image on a normal image display medium and a second image forming portion for forming an image on a reversible image display medium and capable of forming an image on the normal image display medium by the first image forming portion and of forming an image on the reversible image display medium by the second image forming portion, comprising the steps of:
transmitting at least one of information about a state of a predetermined item in the image forming apparatus, information about a setting state for image formation in the image forming apparatus and information about an input state caused by a user in the image forming apparatus to an image information input apparatus for transmitting image data to the image forming apparatus; and
carrying out, based on at least one of the information to be transmitted from the image forming apparatus to the image information input apparatus, an input state caused by the user in the image information input apparatus, the image data in the image information input apparatus, an application software to be used in the image information input apparatus and a type of the image information input apparatus,
at least one of (1) selection of a method of processing the image data to be transmitted to the image forming apparatus in the image information input apparatus, (2) change of the state of the predetermined item of the image forming apparatus and (or) the setting state for image formation of the image forming apparatus in the image information input apparatus, and (3) change of the state of the predetermined item of the image forming apparatus and (or) the setting state for image formation of the image forming apparatus in the image forming apparatus.

3. A computer readable recording medium storing a program for controlling an image forming apparatus comprising a first image forming portion for forming an image on a normal image display medium and a second image forming portion for forming an image on a reversible image display medium and capable of forming an image on the normal image display medium by the first image forming portion and of forming an image on the reversible image display medium by the second image forming portion, the program enabling the computer to perform the steps of:
receiving information about the image forming apparatus transmitted from the image forming apparatus to an image information input apparatus for transmitting image data to the image forming apparatus; and
executing at least one of (1) selection of a method of processing the image data to be transmitted to the image forming apparatus in the image information input apparatus and (2) change of a state of the image forming apparatus in the image information input apparatus, based on at least one of the information to be transmitted from the image forming apparatus to the image information input apparatus and information about the image information input apparatus.

4. A computer readable recording medium storing a program for controlling an image forming apparatus comprising a first image forming portion for forming an image on a normal image display medium and a second image forming portion for forming an image on a reversible image display medium and capable of forming an image on the normal image display medium by the first image forming portion and of forming an image on the reversible image display medium by the second image forming portion, the program enabling the computer to perform the steps of:
receiving information about a state of a predetermined item in the image forming apparatus, information about a setting state for image formation in the image forming apparatus and information about an input state caused by a user in the image forming apparatus, which are transmitted from the image forming apparatus to an image information input apparatus for transmitting image data to the image forming apparatus; and
executing at least one of (1) selection of a method of processing the image data to be transmitted to the image forming apparatus in the image information input apparatus and (2) change of the state of the predetermined item of the image forming apparatus and (or) the setting state for image formation of the image forming apparatus in the image information input apparatus, based on at least one of the information to be transmitted from the image forming apparatus to the image information input apparatus, an input state caused by the user in the image information input apparatus, the image data in the image information input apparatus, an application software to be used in the image information input apparatus and a type of the image information input apparatus.
